(19) United States
(12) Patent Application Publication
(10) Pub. No.: US 2025/0362686 A1
(43) Pub. Date: Nov. 27, 2025

(54) COMPUTING COLLISION SPHERES FOR AUTONOMOUS ROBOTIC MACHINES AND APPLICATIONS

(71) Applicant: NVIDIA Corporation, Santa Clara, CA (US)

(72) Inventors: Bryan Peele, Raleigh, NC (US); Ronald Charles Babich, JR., Murrysville, PA (US)

(21) Appl. No.: 18/671,319

(22) Filed: May 22, 2024

(51) Int. Cl. G05D 1/622; B25J 9/16

(52) U.S. Cl. CPC G05D 1/637; B25J 9/1676

(57) ABSTRACT

In various examples, determining collision spheres for machines and applications is described herein. Systems and methods described herein use one or more parameters, such as a maximum number of points and/or an overshoot distance, to determine a candidate set of spheres associated with a mesh of an object. For instance, the maximum number of points may be used to generate a grid of points associated with the mesh and the overshoot distance may be used to then generate the candidate set of spheres that are centered at the points included in the grid. The systems and methods described herein may then sample a number of points located on a surface of the mesh and use the sampled points to remove (e.g., prune) one or more spheres from the candidate set of spheres in order to generate a final set of spheres for the object.

### BACKGROUND

Motion generation algorithms for autonomous or semi-autonomous machine operation often rely on performing collision checks between a geometry associated with a machine and obstacles in an environment in which the machine is navigating. For instance, when performing trajectory optimization, sample-based planning, reactive motion control, collision-aware inverse kinematics, and/or any other techniques for machine control, it may be important to determine whether a machine will collide with an obstacle. Some conventional systems that perform such collision checks may use a mesh to represent a geometry of a machine, and then determine whether the mesh intersects with an obstacle. However, based on the number of portions (e.g., triangles) and/or points associated with a mesh, performing such collision checks may require a large amount of computing resources, such as processing and/or memory and/or transport bandwidth resources, and/or time.

### SUMMARY

More recently, as an alternative to the mesh-based approach for machine (robotic) planning and control, conventional systems have begun to represent machines using a set of collision spheres in order to improve the performance of performing collision checks. With collision spheres, components of the machine and/or machine platform are represented using a simplified virtual representation that fully encloses the machine and its constituent components in a series of spheres. These spheres are typically calculated using a radius around points in space corresponding to the components of the machine. When representing a machine using collision spheres, it may be desirable to minimize an “overshoot distance” associated with the spheres, where the overshoot distance is associated with a distance at which the spheres extend past a mesh of the machine, and/or minimize a number of spheres that are used to represent the machine. As such, these conventional systems may rely on users to define various parameters associated with creating the spheres, such as spacings between and/or locations of voxels that represent the centers of spheres. However, using such defined parameters may limit how well the spheres actually represent the mesh associated with the machine. Additionally, when optimizing the set of spheres in order to generate a final set of spheres for representing the machine, these conventional systems may perform unnecessary operations, such as initially removing any spheres that are completely enclosed by other spheres, and/or may use surface voxels to identify other spheres that may be removed, which may require large amounts of computing resources to perform.

Embodiments of the present disclosure relate to computing collision spheres for autonomous and/or semi-autonomous machines and applications. Systems and methods described herein use one or more parameters, such as a maximum number of points and/or an overshoot distance, to determine (optimize) a candidate set of spheres associated with a mesh of an object. For instance, the maximum number of points may be used to generate a grid of points associated with the mesh, and the overshoot distance may be used to then generate the candidate set of spheres that are centered at the points included in the grid. The systems and methods described herein may then sample a number of points located on a surface of the mesh, and use the sampled points to remove (e.g., prune) one or more spheres from the candidate set of spheres in order to generate a final set of spheres for the object. For instance, one or more spheres that do not enclose one or more of these points may initially be removed from the candidate set of spheres, one or more spheres that enclose one or more points that are not enclosed by any other sphere may be added to the candidate set of spheres, and one or more spheres that enclose one or more points that are also enclosed by one or more other spheres may then be removed from the candidate set of spheres. In some instances, these processes of adding and removing spheres may be performed using multiple iterations in order to generate the final set of spheres.

In contrast to conventional systems, such as the conventional systems described above, the systems of the current disclosure, in some embodiments, may use a maximum number of points to generate a grid of points that bisects a bounding shape associated with the mesh at a number of planes and also centers one or more points with respect to the mesh. As such, the systems of the current disclosure may space the points along one or more axes of the mesh to maximally distribute spacing between the points. This provides multiple improvements over the conventional systems that merely use a grid of voxels with fixed spacing, since the spaced grid of voxels may include a large number of voxels in many circumstances, which then increases the amount of computing resources needed for processing and/or may include voxels distributed at locations that are not relevant for generating spheres. Additionally, these conventional systems use voxels rather than just points, which also increases the computing needed when processing the voxels, such as when determining whether voxels are located inside a mesh, outside of the mesh, or on a surface of the mesh.

Furthermore, in contrast to the conventional systems, the systems of the present disclosure, in some examples, use points that are randomly sampled on a surface of the mesh to prune one or more spheres from the candidate set of spheres. As described above, the conventional systems may again use voxels to perform this pruning, which requires an increased amount of processing to determine whether candidate spheres enclose voxels for pruning. For instance, by using points instead of voxels, the systems of the present disclosure may require less computing resources, such as when identifying which candidate spheres enclose points for pruning. Additionally, and as will be described in more detail herein, the systems of the present disclosure may further reduce the processing time and/or computing resources by initially mapping points to enclosed spheres and then using this mapping to perform the pruning.

### BRIEF DESCRIPTION OF THE DRAWINGS

The present systems and methods for determining collision spheres for autonomous and/or semi-autonomous machines and applications are described in detail below with reference to the attached drawing figures, wherein:

FIG. 1 illustrates an example data flow diagram for a process of determining collision spheres for machines and applications, in accordance with some embodiments of the present disclosure;

FIG. 2 illustrates an example of a mesh associated with an object, in accordance with some embodiments of the present disclosure;

FIG. 3 illustrates an example of determining a bounding shape associated with a mesh, in accordance with some embodiments of the present disclosure;

FIGS. 4A-4B illustrate examples of determining sets of points within bounding shapes associated with meshes, in accordance with some embodiments of the present disclosure;

FIG. 5A-5B illustrate examples of classifying points as either being located inside a mesh or outside of the mesh, in accordance with some embodiments of the present disclosure;

FIG. 6 illustrates an example of determining distances between points and a mesh, in accordance with some embodiments of the present disclosure;

FIGS. 7A-7C illustrate an example of using points to generate a candidate set of spheres associated with a mesh, in accordance with some embodiments of the present disclosure;

FIG. 8 illustrates an example of determining a set of points on a surface of a mesh for pruning a candidate set of spheres associated with the mesh, in accordance with some embodiments of the present disclosure;

FIG. 9 illustrates an example of generating mappings associated with points located on a surface of a mesh, in accordance with some embodiments of the present disclosure;

FIGS. 10A-10D illustrate an example of selecting candidate spheres for inclusion in a final set of spheres, in accordance with some embodiments of the present disclosure;

FIG. 11 illustrates an example of using a final set of spheres to determine whether an object may be in collision with another object, in accordance with some embodiments of the present disclosure;

FIG. 12 illustrates an example of a final set of spheres associated with a mesh, where the final set of spheres is generated using a smaller overshoot distance as compared to the final set of spheres from the example of FIG. 10D, in accordance with some embodiments of the present disclosure;

FIG. 13 illustrates an example of determining a set of spheres associated with detecting actual contact with a mesh, in accordance with some embodiments of the present disclosure;

FIG. 14 illustrates a flow diagram showing a method for determining collision spheres associated with an object, in accordance with some embodiments of the present disclosure;

FIG. 15 illustrates a flow diagram showing another method for determining collision spheres associated with an object, in accordance with some embodiments of the present disclosure;

FIG. 16A is an illustration of an example autonomous vehicle, in accordance with some embodiments of the present disclosure;

FIG. 16B is an example of camera locations and fields of view for the example autonomous vehicle of FIG. 16A, in accordance with some embodiments of the present disclosure;

FIG. 16C is a block diagram of an example system architecture for the example autonomous vehicle of FIG. 16A, in accordance with some embodiments of the present disclosure;

FIG. 16D is a system diagram for communication between cloud-based server(s) and the example autonomous vehicle of FIG. 16A, in accordance with some embodiments of the present disclosure;

FIG. 17 is a block diagram of an example computing device suitable for use in implementing some embodiments of the present disclosure; and

FIG. 18 is a block diagram of an example data center suitable for use in implementing some embodiments of the present disclosure.

### DETAILED DESCRIPTION

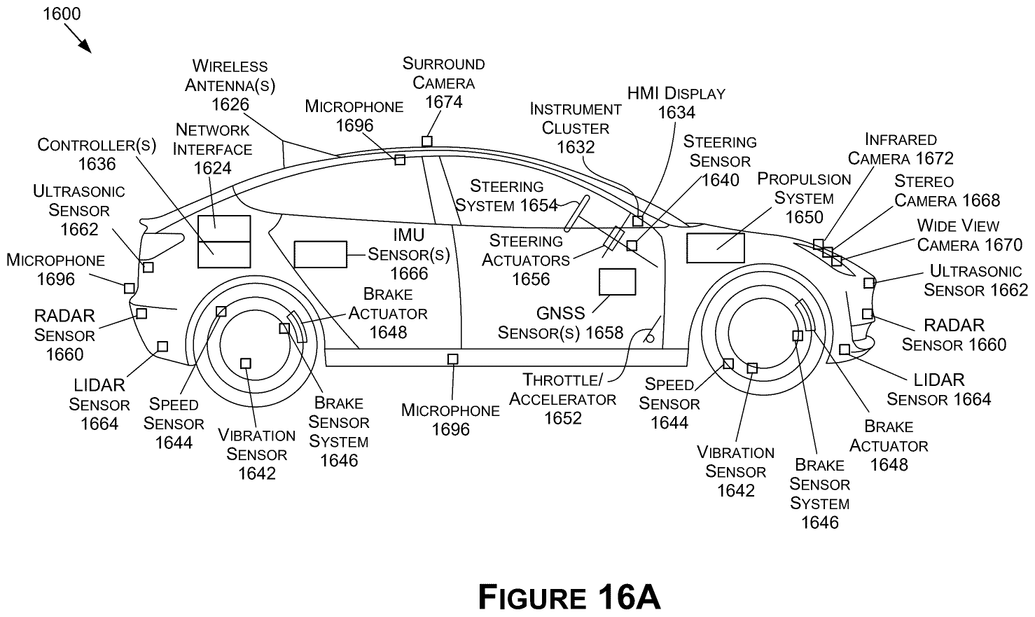

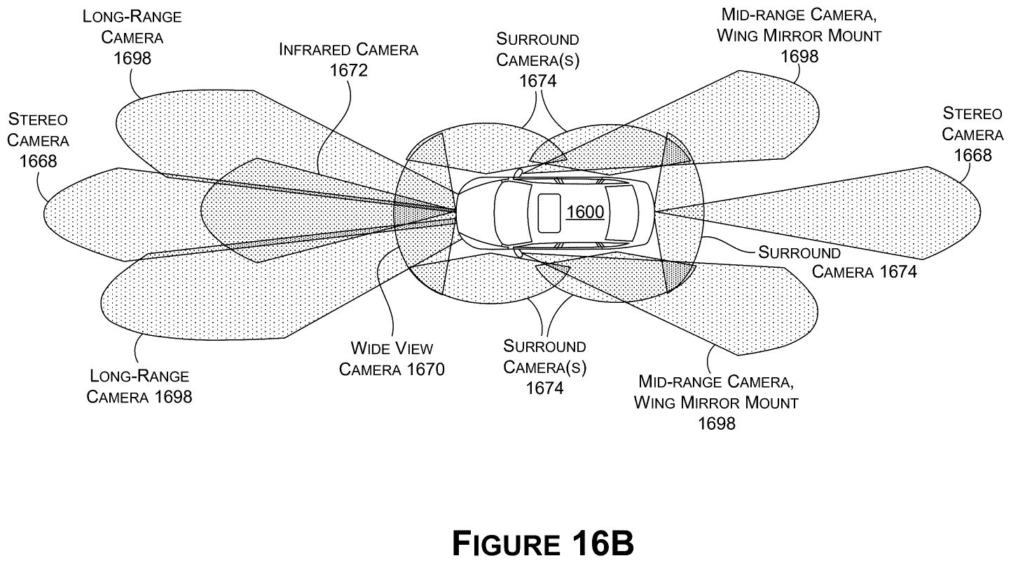

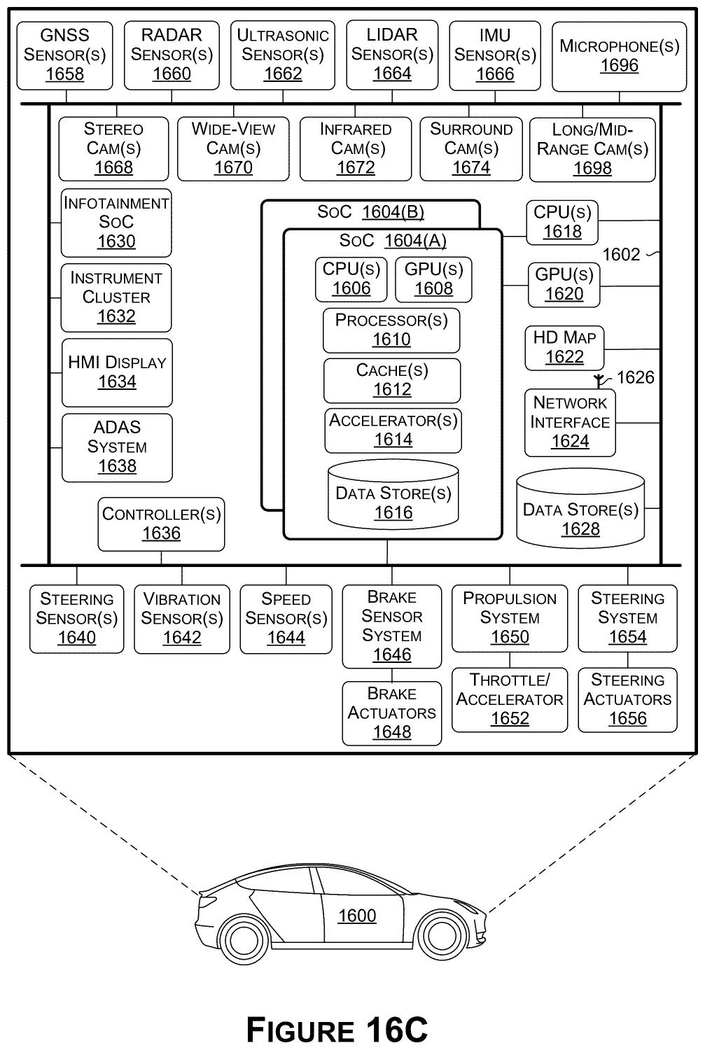

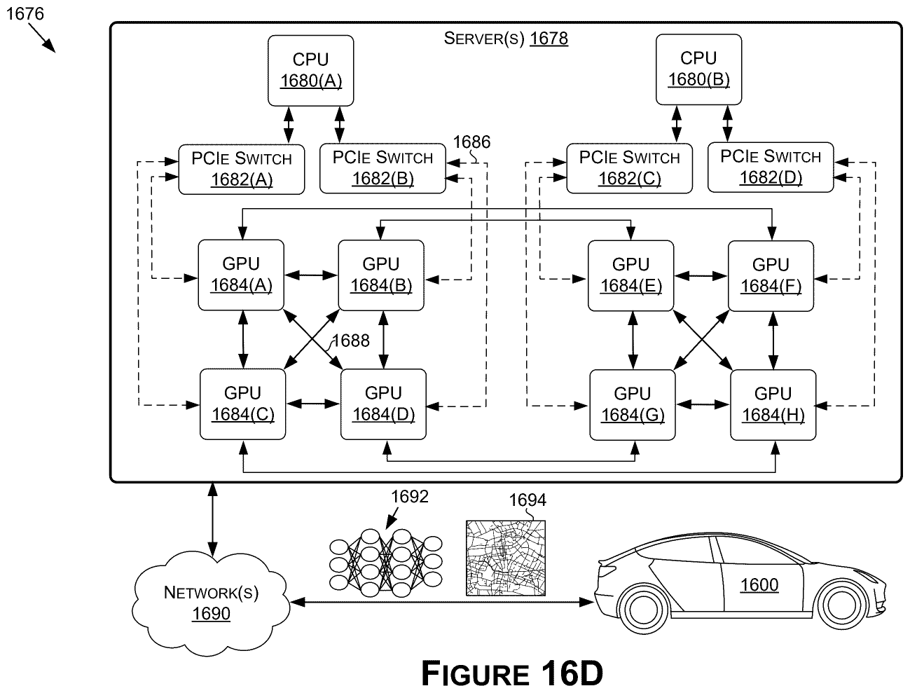

Systems and methods are disclosed related to determining collision spheres for autonomous and/or semi-autonomous machines and applications. Although the present disclosure may be described with respect to an example autonomous or semi-autonomous vehicle or machine 1600 (alternatively referred to herein as “vehicle 1600,” “ego-vehicle 1600,” “ego-machine 1600,” or “machine 1600,” an example of which is described with respect to FIGS. 16A-16D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to sphere generation and/or collision detection, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may generate, obtain, receive, and/or determine a mesh associated with an object. As described herein, the mesh may include any type of mesh, such as a polygon mesh (e.g., a triangular mesh), that represent the object. The system(s) may then generate a bounding shape that at least partially encloses the mesh. As described herein, a bounding shape may include, but is not limited to, a bounding cuboid, a bounding cube, a bounding cylinder, a bounding sphere, a bounding pyramid, and/or any other type of three-dimensional shape that may be used to enclose the mesh. Additionally, the system(s) may use one or more techniques to optimize the bounding shape with respect to the mesh. For instance, in some examples, the system(s) may align the bounding shape with one or more principal axes associated with the mesh, determine a size associated with the bounding shape that is based at least on a size of the mesh, and/or perform any other optimization techniques.

The system(s) may then determine an initial set of points located within the bounding shape. As described herein, in some examples, the system(s) may determine a number of points to include in the initial set of points based at least on one or more parameters, such as a parameter provided by one or more users that indicates a maximum number of points. Additionally, the system(s) may determine the locations of the points using one or more techniques that cause the points to be optimized with respect to the mesh and/or the bounding shape. For instance, in some examples, the system(s) may determine the locations of the points using a grid pattern, where the grid is arranged such that there is a two-dimensional grid of points at one or more (e.g., each) of the planes of the bounding shape. In some examples, when generating such a grid, an odd number of points may be used in one or more (e.g., each) of the directions such that the grids are aligned with the center lines of the bounding shape. As will be described in more detail herein, by performing such processes, the spacing of the points may be adaptive along the axes of the bounding shape, thus maximally distributing the spacing of the points within the bounding shape.

The system(s) may then determine additional information associated with the initial set of points. For instance, the system(s) may use one or more techniques to classify whether the points are located inside the mesh or outside of the mesh. In some examples, and as described in more detail herein, to classify a point, the system(s) may use ray casting to project a number of rays (e.g., one ray, four rays, six rays, ten rays, etc.) from the point, where the system(s) is then able to determine whether the point is located inside the mesh or outside of the mesh based at least on a number of surfaces (e.g., a number of polygons) of the mesh for which one or more of the rays contact. Additionally, the system(s) may determine distances between the points and the surface of the mesh that represent the object. In some examples, to determine a distance for a point, the system(s) may determine the distance between the location of the point and the location of the closest point located on the surface of the mesh (e.g., the location of the closest polygon associated with the mesh). While these are just a couple of examples of additional information that the system(s) may determine for the points, in other examples, the system(s) may determine additional and/or alternative information associated with the points.

The system(s) may then use the information associated with the points, along with one or more additional parameters associated with spheres, to generate a candidate set of spheres associated with the mesh. For instance, the system(s) may determine an overshoot distance that spheres may extend past the mesh. In some examples, the system(s) may determine the overshoot distance based at least on one or more users setting the overshoot distance. The system(s) may then use classifications of whether the points are located inside or outside of the mesh, the distances between the points and the mesh, and the overshoot distance to remove one or more points from the initial set of points in order to generate a final set of points. For instance, in some examples, the system(s) may remove one or more points that are located outside of the mesh and include one or more distances that are equal to or greater than half of the overshoot distance.

The system(s) may then generate a candidate set of spheres associated with the mesh using the final set of points associated with the mesh. For instance, in some examples and for a point located inside the mesh, the system(s) may determine a sphere as being centered at the point and including a radius that is based at least on the distance between the point and the mesh and the overshoot distance. For example, the system(s) may determine the radius by adding the overshoot distance to the distance between the point and the mesh. Additionally, in some examples, and for a point that is located outside of the mesh, the system(s) may again determine a sphere as being centered at the point and including a radius that is based at least on the distance between the point and the mesh and the overshoot distance, but using a different technique. For example, the system(s) may determine the radius by subtracting the overshoot distance by the distance between the point and the mesh.

The system(s) may then perform one or more processes in order to generate a final set of spheres that includes at least a portion of the candidate set of spheres. For instance, the system(s) may determine a set of points located on a surface of the mesh. In some examples, the system(s) determines the set of points using sampling, such as by uniformly sampling the surface of the mesh. In some examples, the system(s) may then use one or more processes to partition the set of points, such as by partitioning the set of points into one or more data structures. As described herein, a data structure may include, but is not limited to, an octant, a multi-level octree, a denser occupancy map, and/or any other type of data structure. The system(s) may then use the set of points and/or the data structure(s) to determine the final set of spheres associated with the mesh.

For instance, in some examples, the system(s) may initially remove one or more spheres from candidate set of spheres that do not enclose at least one point from the set of points. Additionally, in some examples, the system(s) may then generate one or more maps (e.g., one or more coverage maps) associated with one or more points from the set of points. For example, and for a point, the system(s) may generate a map that indicates one or more (e.g., each) of the spheres that encloses the point. In some examples, such as to reduce the amount of computing resources needed to perform the mapping and/or to reduce the time it takes to perform the mapping, the system(s) may test one or more (e.g., each) of the spheres for overlap with the bounding shape of one or more (e.g., each) of the data structure(s). In some examples, such as to again reduce the time it takes to perform the mapping, the system(s) may determine whether the spheres overlap with the points in parallel.

The system(s) may then determine whether one or more points from the set of points are only enclosed by a single sphere of the candidate set of spheres, such as by using the map(s). If the system(s) determines that a point is enclosed by only a single sphere, then the system(s) may add that sphere to the final set of spheres. Additionally, the system(s) may remove one or more other points from the set of point that are also enclosed by the sphere from consideration for adding and/or removing additional spheres. In some examples, the system(s) may perform such processes since, if a point is enclosed by only a single sphere, that sphere may be needed to ensure full coverage of the mesh.

After adding this candidate sphere(s) to the final set of spheres, the system(s) may then determine if at least one sphere from the candidate set of spheres encloses one or more points that are all further enclosed by at least one other sphere. If the system(s) determines that all of the point(s) of a sphere is further enclosed by at least one other sphere, then the system(s) may remove at least that sphere from being included in the final set of spheres. In some examples, the system(s) may use one or more factors when determining which sphere(s) to remove. For example, if all of the points from multiple spheres are also enclosed by other spheres, the system(s) may remove the smallest sphere, the largest sphere, the sphere that encloses the least number of points, the sphere that encloses the greatest number of points, the sphere that includes a center located outside of the mesh, the sphere that includes a center that is located inside of the mesh, and/or any other sphere.

In some examples, the system(s) may continue to perform these processes of adding one or more spheres for which one or more points are only enclosed by and/or removing one or more spheres for which multiple points are enclosed by for one or more iterations. For example, the system(s) may continue to perform these processes until all surface points are covered by one or more spheres, there are no more spheres left for consideration (e.g., all the spheres have either been added to the final set of spheres or removed), a set number of iterations has been performed (e.g., one iteration, five iterations, ten iterations, fifty iterations, etc.), and/or any other event occurs. In some examples, after performing these processes, if one or more points still exist for which one or more spheres from the final set of spheres does not enclose, the system(s) may then generate one or more new spheres to add to the final set of spheres. For example, and for a point, the system(s) may add a new sphere that is centered at the point and has a radius that includes the overshoot distance.

The system(s) may then perform one or more processes using the final set of spheres determined for the mesh that represents the object. For a first example, the system(s) may store data representing the final set of spheres in association with the mesh and/or the object. For a second example, the system(s) may use the final set of spheres when determining one or more operations that the object is to perform. For instance, the system(s) may use the final set of spheres to determine whether the object may collide with another object when performing trajectory optimization, sampling-based planning, reactive motion control, collision-aware inverse kinematics, and/or any other type of control associated with the object.

In some examples, by using the overshoot distance to ensure that the final set of spheres extend past the surface of the mesh, the final set of spheres may be used to determine when the object may collide with another object in order to avoid such collisions. However, in some examples, the system(s) may want to determine when the object is actually contacts (e.g., collides) with another object, such as when a planned trajectory of the object is to contact with the other object. For example, if the object includes a gripper (and/or other object) that is configured to pick one or more other objects up, then the system(s) may want to determine when the gripper is actually in contact with the other object(s). As such, the system(s) may use the final set of spheres (and/or perform one or more of these processes to generate a new set of spheres) to make such determinations.

For instance, the system(s) may initially remove one or more (e.g., each) of the spheres from the final set of spheres that include one or more center points that are located outside of the mesh. The system(s) may then determine updated radiuses for the remining spheres from the final set of spheres. In some examples, the system(s) may determine the updated radiuses by subtracting the overshoot distance along with an inlet distance from the radiuses of the spheres. By performing such subtractions, and since these spheres includes centers that are located inside the mesh, the updated spheres may not extend past the surface of the mesh. For instance, if the inlet distance is five centimeters, then the spheres may extend at most within five centimeters within the surface of the mesh. The system(s) may then use these updated spheres to determine whether there is a collision with an object, such as by using similar collision detection processes as those the system(s) would use with respect to the final set of spheres. However, since these updated spheres do not extend past the surface of the mesh, unlike the final set of spheres, if the system(s) determines that there is a collision with another object, then the mesh and/or the object represented by the mesh is in actual contact with the other object.

It should be noted that, while the examples herein describe determining a final set of spheres for a mesh that represents an object, in other examples, similar processes may be used to generate multiple final sets of spheres for multiple meshes that represent an object. For instance, if an object includes different parts, such as a base and a gripper, then the system(s) may perform these processes to determine a first final set of spheres for the first part of the object and a second final set of spheres for the second part of the object. Additionally, in such examples, the system(s) may use the same parameters for each final set of spheres and/or may use different parameters for the final sets of spheres. For example, the system(s) may use a first overshoot distance for the first set of spheres and second, different overshoot distance for the second set of spheres. In some examples, the system(s) may perform such processes since it may be more important to be more accurate when determining if the first portion of the object is in contact with another object as compared to the second portion of the object.

Additionally, while the examples herein describe determining a final set of spheres associated with the mesh and/or the object, in some examples, the system(s) may perform one or more similar processes to determine other types of shapes associated with the mesh and/or the object. For example, the system(s) use one or more similar processes to determine cubes, cuboids, cylinders, pyramids, and/or any other type of three-dimensional shape that may be used to represent the mesh and/or the object.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems performing operations using one or more large language models (LLMs), systems performing operations using one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

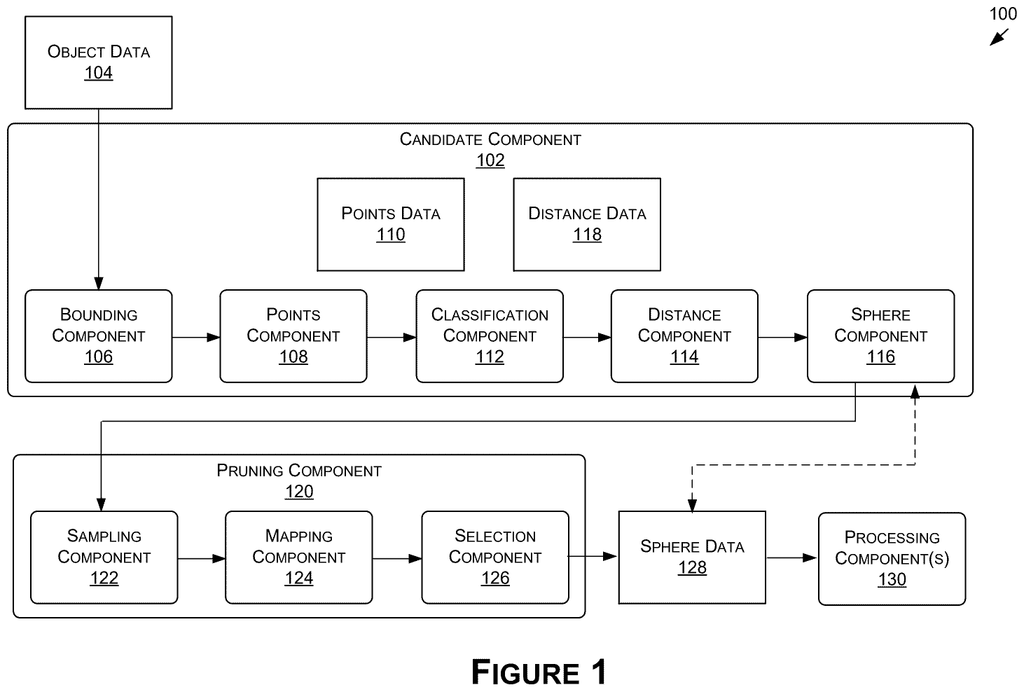

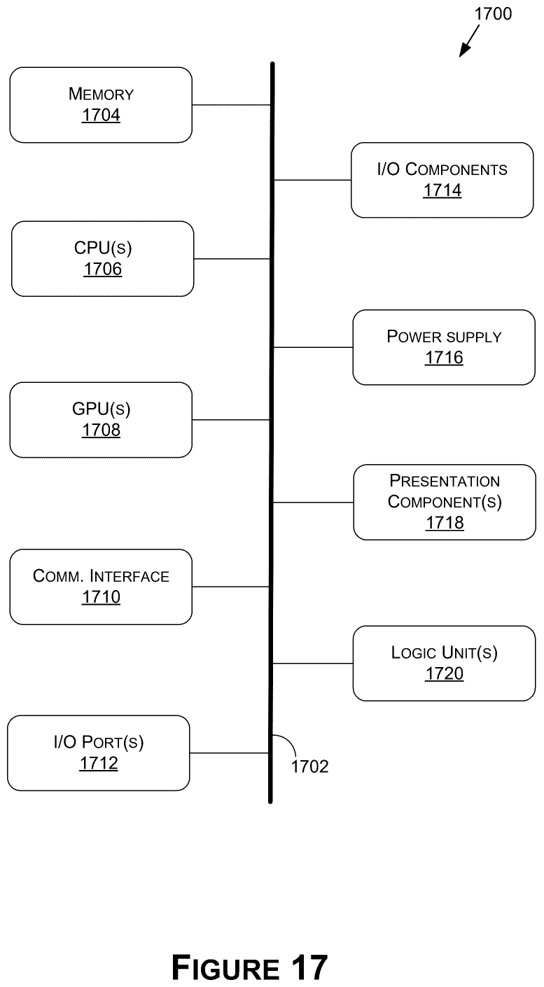

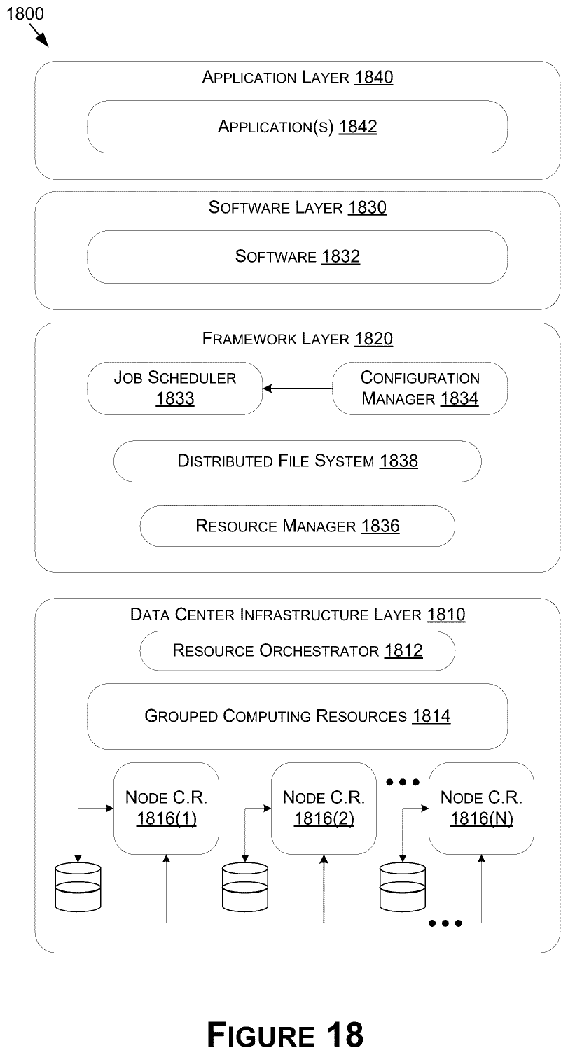

With reference to FIG. 1, FIG. 1 illustrates an example data flow diagram for a process 100 of determining collision spheres for machines and applications, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 1700 of FIG. 17, and/or example data center 1800 of FIG. 18.

The process 100 may include a candidate component 102 receiving object data 104 associated with an object. In some examples, the object data 104 may represent the object, such as the shape of the object. As described herein, an object may include, but is not limited to, a robot, a machine, a vehicle, a traffic feature, a structure, an animated character, and/or any other type of object. Additionally, or alternatively, in some examples, the object data 104 may represent a mesh associated with the object. As described herein, the mesh may include any type of mesh, such as a polygon mesh (e.g., a triangular mesh), that represent the object. While the examples herein describe representing the object using a single mesh, in other examples, the object may be represented using multiple meshes. For instance, different parts of the object may be represented using respective meshes.

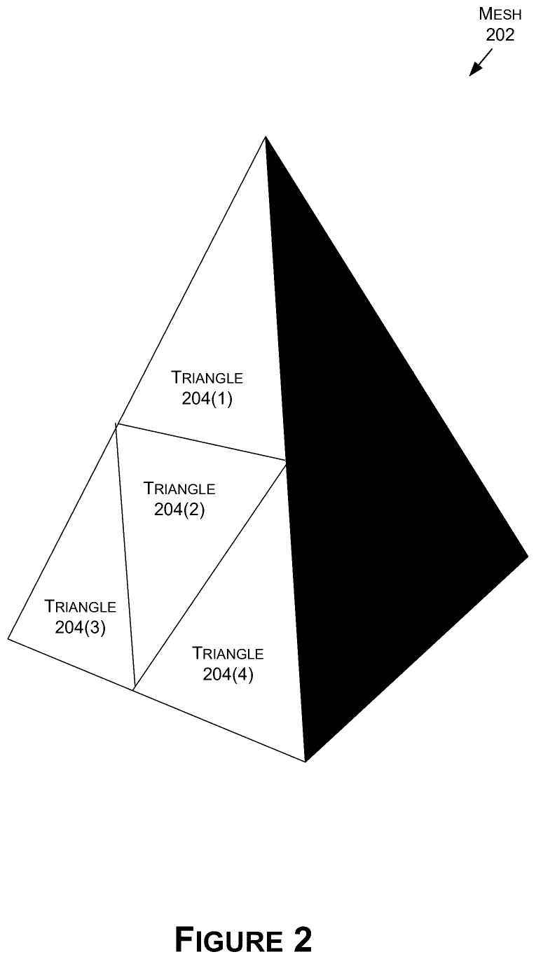

For instance, FIG. 2 illustrates an example of a mesh 202 associated with an object, in accordance with some embodiments of the present disclosure. While the example of FIG. 2 illustrates the object as including a pyramid and/or including a shape that is similar to a pyramid, in other examples, the object may include any other type of object, such as a machine and/or robot. Additionally, while the example of FIG. 2 illustrates the mesh 202 as including a triangular mesh that includes at least triangles 204(1)-(8) (also referred to singularly as “triangle 204” or in plural as “triangles 204”), in other examples, the mesh 202 may include any other type of mesh that is associated with any number of polygons.

Referring back to the example of FIG. 1, the process 100 may include the candidate component 102 using one or more of the processes described herein to generate a candidate set of spheres associated with the mesh. For instance, and as shown, the process 100 may include the candidate component 102 using a bounding component 106 to determine a bounding shape that at least partially encloses the mesh. As described herein, a bounding shape may include, but is not limited to, a bounding cuboid, a bounding cube, a bounding cylinder, a bounding sphere, a bounding pyramid, and/or any other type of three-dimensional shape that may be used to enclose the mesh. Additionally, the bounding component 106 may use one or more techniques to optimize the bounding shape with respect to the mesh. For instance, in some examples, the bounding component 106 may align the bounding shape with one or more principal axes associated with the mesh, determine a size associated with the bounding shape that is based at least on a size of the mesh, and/or perform any other optimization techniques.

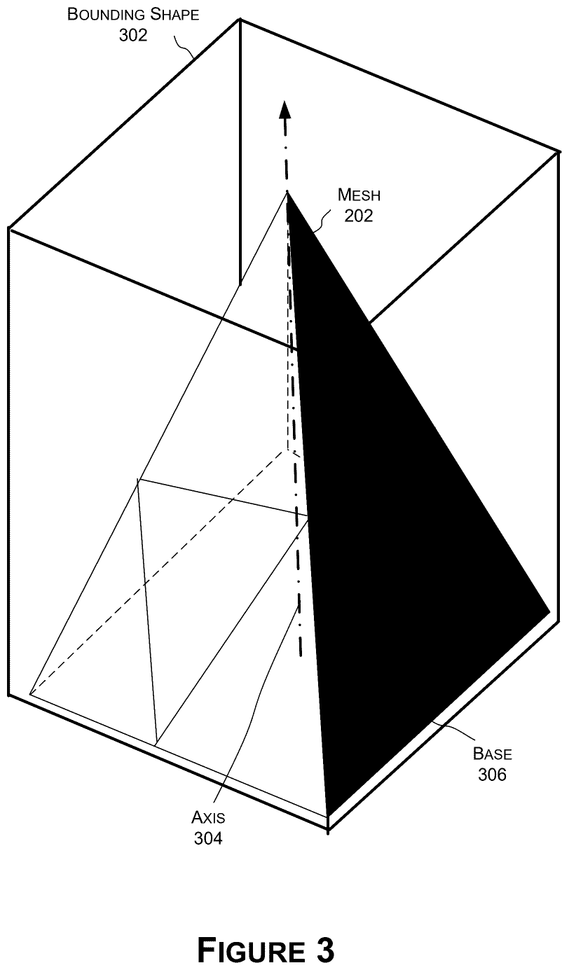

For instance, FIG. 3 illustrates an example of determining a bounding shape 302 associated with the mesh 202, in accordance with some embodiments of the present disclosure. As shown, the bounding component 106 may determine the bounding shape 302 as including a cuboid that completely encloses the mesh 202. However, in other examples, the bounding component 106 may determine the bounding shape 302 as including any other type of shape that at least partially encloses the mesh 202. Additionally, the bounding component 106 may determine the bounding shape 302 such that the bounding shape 302 is aligned with at least one principal axis associated with the mesh 202. For instance, and in the example of FIG. 3, the bounding shape 302 may be aligned with an axis 304 that extends through a center of a base 306 of the mesh 202 and to a top of the mesh 202.

Referring back to the example of FIG. 1, the process 100 may include the candidate component 102 using a points component 108 to determine an initial set of points located within the bounding shape. As described herein, in some examples, the points component 108 may determine a number of the points based at least on one or more parameters, such as a parameter provided by one or more users that indicates the number of points (e.g., the maximum number of points) as represented by points data 110. Additionally, the points component 108 may determine the locations of the points using one or more techniques that cause the points to be optimized with respect to the mesh and/or the bounding shape. For instance, in some examples, the points component 108 may determine the locations of the points using a grid pattern, where the grid is arranged such that there is a two-dimensional grid of points at one or more (e.g., each) of the planes of the bounding shape. As will be described in more detail herein, by performing such processes, the spacing of the points may be adaptive along the axes of the bounding shape, thus maximally distributing the spacing of the points within the bounding shape. However, in other examples, the points component 108 may determine the locations of the points within the bounding shape using any other techniques.

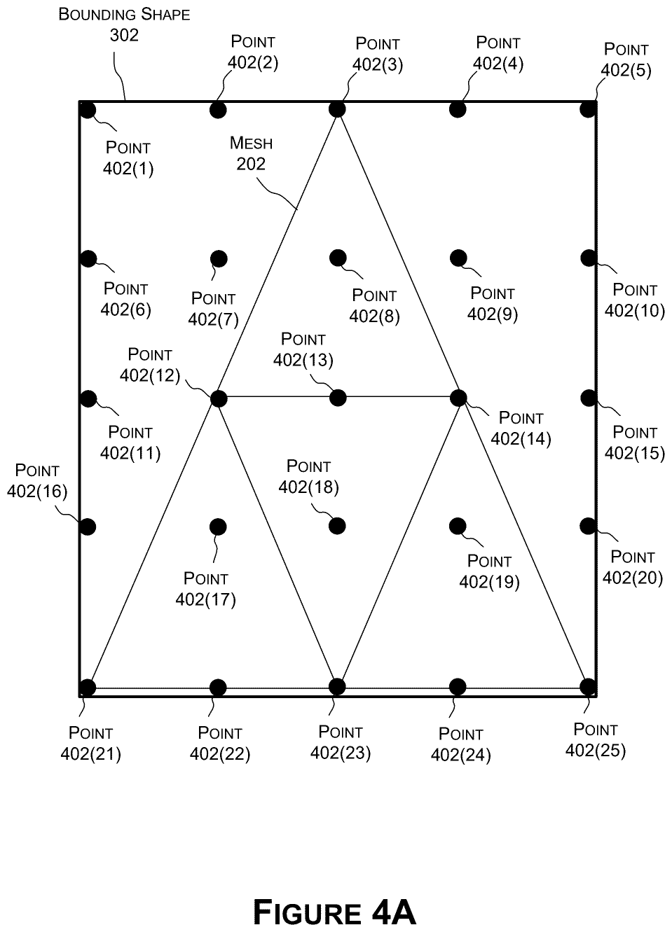

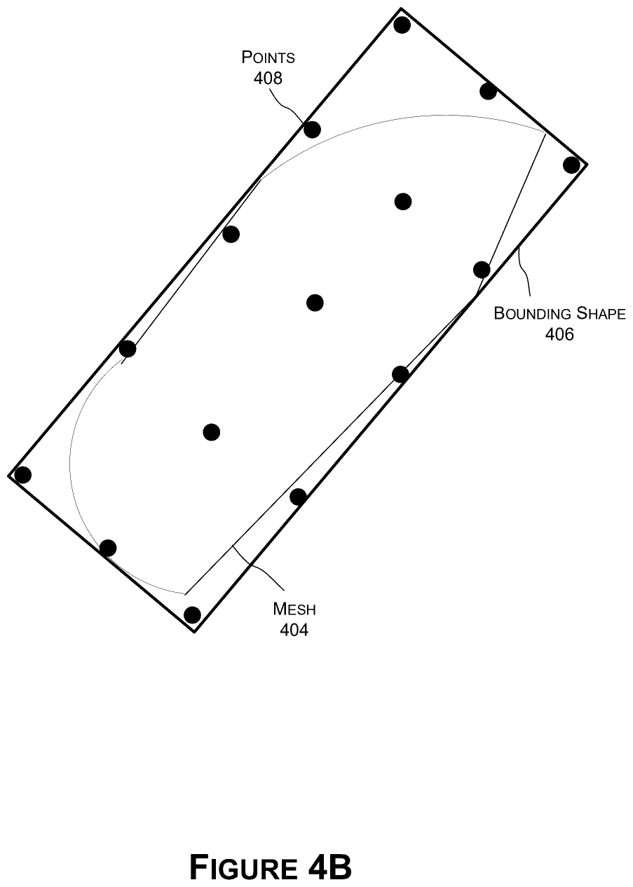

For instance, FIG. 4A illustrates an example of determining locations of points 402(1)-(25) (also referred to singularly as “point 402” or in plural as “points 402”) within the bounding shape 302 associated with the mesh 202, in accordance with some embodiments of the present disclosure. As shown, the example of FIG. 4A may represent a plane of the mesh 202 from the examples of FIGS. 2-3. Additionally, the points component 108 may distribute the points 402 using a pattern throughout the plane, such as uniformly using a grid pattern. Furthermore, the number of points included within the pattern may depend on the maximum number of points that are to be located within the bounding shape 302. For example, if the maximum number of points includes 125 points, then the points component 108 may distribute the points 402 using a similar pattern of 25 points at 5 different planes associated with the mesh 202.

Next, and as illustrated by the example of FIG. 4B, for a new type of mesh 404, a bounding shape 406 may originally be oriented such that the bounding shape 406 better fits the mesh 404. In some examples, the bounding shape 406 is oriented with respect to the mesh 404 by computing a principal axis associated with the mesh 404 and then aligning the bounding shape 406 with respect to the principal axis. In some examples, the bounding shape 406 is oriented with respect to the mesh 404 by minimizing a volume of the bounding shape 406 while still fully enclosing the mesh 404. In any example, the points component 108 may then determine points 408 (although only one is labeled for clarity reasons) within the bounding shape 406. As described herein, in some examples, the points component 108 may distribute the points using a pattern throughout the plane, such as uniformly using a grid pattern. Additionally, in some examples, when generating such grids, the points 408 component 108 may use an odd number of points in one or more (e.g., each) of the directions such that the grids are aligned with the center lines of the bounding shape 406.

Referring back to the example of FIG. 1, the process 100 may include the candidate component 102 using a classification component 112 to classify the initial set of points as being located inside the mesh or outside of the mesh. As described herein, the classification component 112 may use any technique to classify the points. For instance, and for a point, the classification component 112 may project a number of rays from the point. As described herein, the number of rays may include, but is not limited to, one ray, four rays, six rays, ten rays, and/or any other number of rays. The classification component 112 may then determine, for each ray, a number of polygons (e.g., triangles) of the mesh that the respective ray intersects. Additionally, for each ray, the classification component 112 may determine (1) that the respective ray indicates that the point is located inside of the mesh when the total number of polygons is odd or (2) that the respective ray indicates that the point is located outside of the mesh when the total number of polygons is even and/or the total number of polygons is zero.

The classification component 112 may then use these determinations for the individual rays to make a final determination associated with the point. For a first example, the classification component 112 may determine that the point is located inside the mesh when a threshold number of rays (e.g., 4 rays, 6 rays, etc.) indicate that the point is located inside the mesh or determine that the point is located outside of the mesh when the threshold number of rays does not indicate that the point is located inside the mesh. For a second example, the classification component 112 may determine that the point is located inside the mesh when all of the rays indicate that the point is located inside the mesh or determine that the point is located outside of the mesh when all of the rays do not indicate that the point is located inside the mesh. While these are just a few example techniques of how the classification component 112 may use the rays to determine whether the point is located inside the mesh or outside of the mesh, in other examples, the classification component 112 may use additional and/or alternative techniques. Additionally, in some examples, the classification component 112 may perform similar processes for one or more (e.g., each) of the other points.

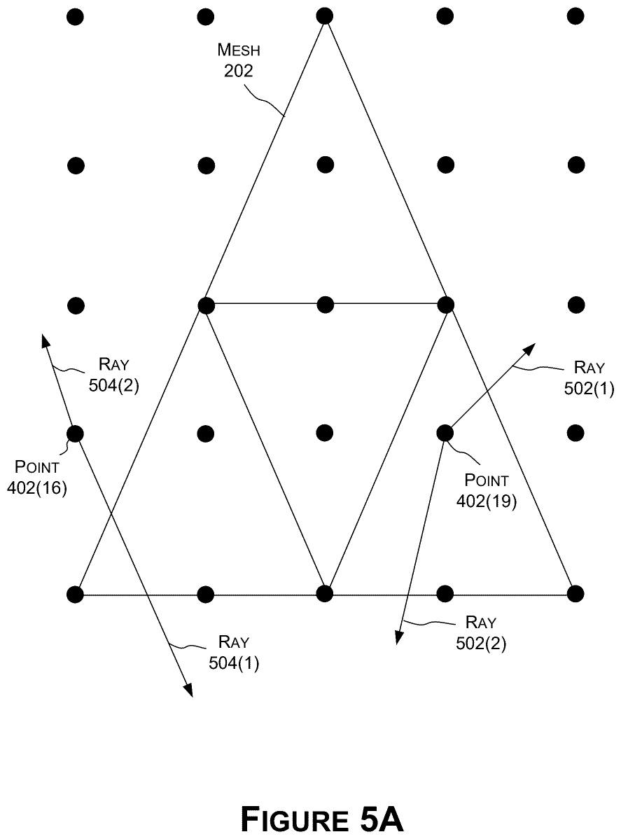

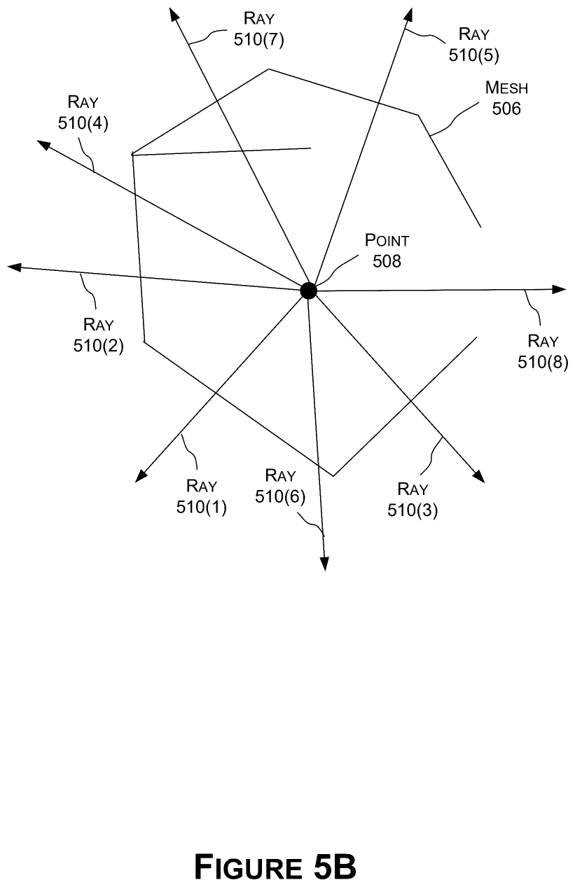

For instance, FIGS. 5A-5B illustrate examples of classifying points as either being located inside a mesh or outside of a mesh, in accordance with some embodiments of the present disclosure. As shown by the example of FIG. 5A, for the point 402(19), the classification component 112 may project at least a first ray 502(1) in a first direction and a second ray 502(2) in a second direction. The classification component 112 may then determine that the first ray 502(1) indicates that the point 402(19) is located inside the mesh 202 based at least on the number of polygons being odd (e.g., 1) and that the second ray 502 (2) also indicates that the point 402(19) is located inside the mesh 202 based at least on the number of polygons again being odd (e.g., 1). As such, the classification component 112 may classify the point 402(19) as being located inside the mesh 202.

Additionally, and for the point 402(16), the classification component 112 may project at least a first ray 504(1) in a first direction and a second ray 504(2) in a second direction. The classification component 112 may then determine that the first ray 504(1) indicates that the point 402(16) is located outside the mesh 202 based at least on the number of polygons being even (e.g., 2) and that the second ray 502(2) also indicates that the point 402(16) is located outside of the mesh based at least on the number of polygons being zero. As such, in the example of FIG. 5A, the classification component 112 may classify the point 402(16) as being outside of the mesh 202. While the example of FIG. 5A illustrates projecting two rays 502(1)-(2) and 504(1)-(2) from both points 402(16) and 402(19), in other examples, the classification component 112 may perform similar processes by projecting any number of rays from the points 402(16) and 402(19). Additionally, in some examples, the classification component 112 may perform similar processes to classify one or more (e.g., each) of the points 402.

Next, and as illustrated by the example of FIG. 5B, for a new mesh 506, the classification component 112 may determine whether a point 508 is located inside the mesh 506 or outside of the mesh 506. For instance, the classification component 112 may project eight rays 510(1)-(8) from the point 508. The classification component 112 may then determine that six rays 510(1)-(6) indicate that the point 508 is located inside the mesh 506 based at least on the number of polygons including one, one ray 510(7) indicates that the point 508 is located outside of the mesh 506 based at least on the number of polygons including two, and one ray 510(8) indicates that the point 508 is located outside of the mesh based at least on the number of polygons including zero. As such, in some examples, the classification component 112 may determine that the point 508 is located inside the mesh based at least on a threshold number and/or threshold percentage of the rays 510(1)-(8) indicating that the point is located inside the mesh 506. However, in other examples, the classification component 112 may determine that the point 508 may not be classified based at least on the individual determinations for the rays 510(1)-(8) being different from one another.

Referring back to the example of FIG. 1, the process 100 may include the candidate component 102 using a distance component 114 to determine distances associated with the points. As described herein, in some examples, the distances may include the shortest distances between the points and a closest point on the mesh (e.g., a closest polygon associated with the mesh). Additionally, in some examples, to determine the distances, the distance component 114 may initially partition the polygons of the mesh into one or more spatial data structures that consist of overlapping axis-aligned bounding boxes where an individual polygon (e.g., each polygon) is contained in a single group of axis-aligned bounding boxes. This way, the distance component 114 may be able to perform one or more (e.g., all) of the distance computations in parallel using the spatial data structure(s).

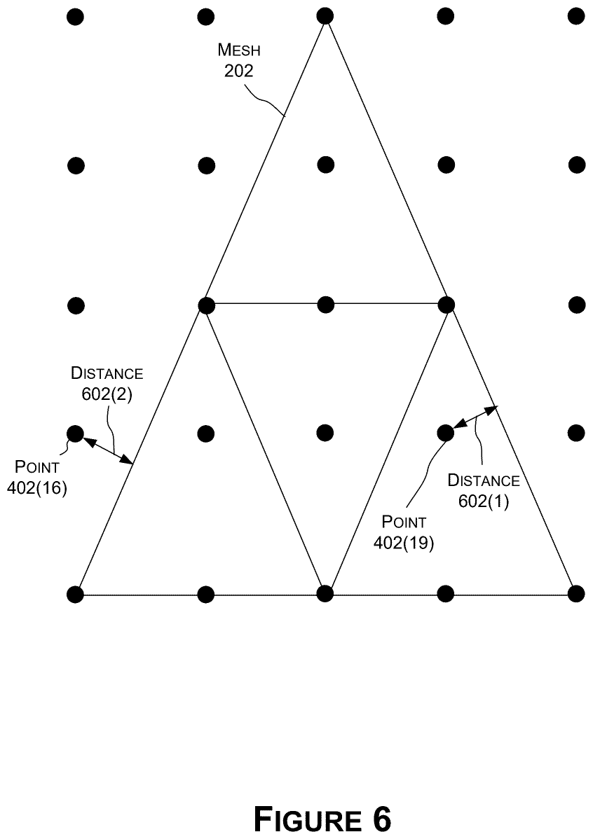

For instance, FIG. 6 illustrates an example of determining distances between the points 402 and the mesh 202, in accordance with some embodiments of the present disclosure. As shown, the distance component 114 may determine a first distance 602(1) between the point 402(19) and the mesh 202 and a second distance 602(2) between the point 402(16) and the mesh 202. As described herein, the first distance 602(1) may include a shortest distance between the point 402(19) and the mesh 202 and the second distance 602(2) may include a shortest distance between the point 402(16) and the mesh 202. For instance, the distance component 114 may determine the first distance 602(1) as being between the point 402(19) and a closest triangle 204 of the mesh 202 and the second distance 602(2) as being between the point 402(16) and a closest triangle 204 of the mesh 202.

Referring back to the example of FIG. 1, the process 100 may include the candidate component 102 using a sphere component 116 to generate a candidate set of spheres associated with the mesh. For instance, the sphere component 116 may determine an overshoot distance that spheres may extend past the mesh, where the overshoot distance may be represented by distance data 118. In some examples, the sphere component 116 may determine the overshoot distance based at least on one or more users setting the overshoot distance. The sphere component 116 may then use classifications of whether the points are located inside or outside of the mesh, the distances between the points and the mesh, and the overshoot distance to remove one or more points from the initial set of points in order to generate a final set of points. For instance, in some examples, the sphere component 116 may remove one or more points that are located outside of the mesh and include one or more distances that are equal to or greater than the overshoot distance.

The sphere component 116 may then generate the candidate set of spheres associated with the mesh using the final set of points associated with the mesh. For instance, in some examples and for a point located inside the mesh, the sphere component 116 may determine a sphere as being centered at the point and including a radius that is based at least on the distance between the point and the mesh and the overshot distance. For example, the sphere component 116 may determine the radius by adding the overshoot distance to the distance between the point and the mesh. Additionally, in some examples, and for a point that is located outside of the mesh, the sphere component 116 may again determine a sphere as being centered at the point and including a radius that is based at least on the distance between the point and the mesh and the overshoot distance, but using a different technique. For example, the sphere component 116 may determine the radius by subtracting the distance between the point and the mesh from the overshoot distance. The sphere component 116 may then perform similar processes for one or more (e.g., each) of the remaining points included in the final set of points.

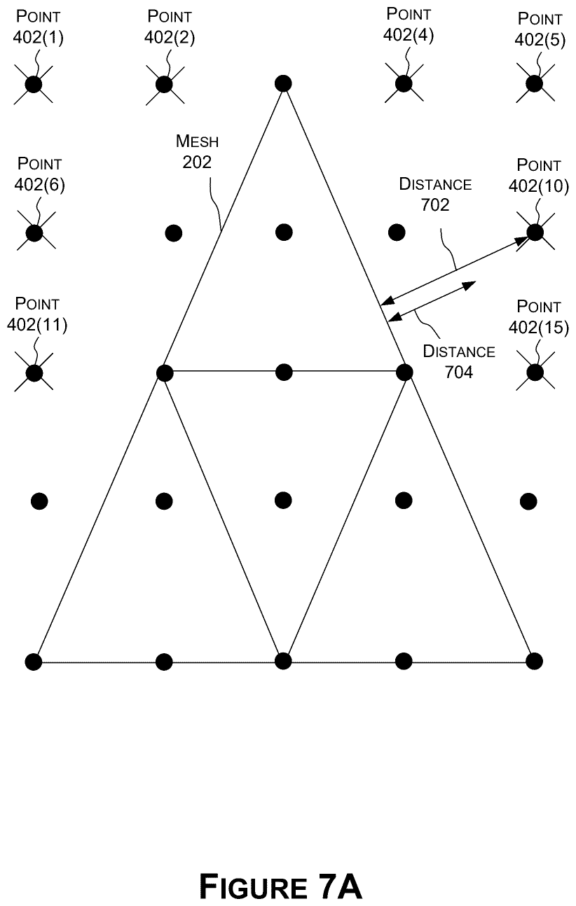

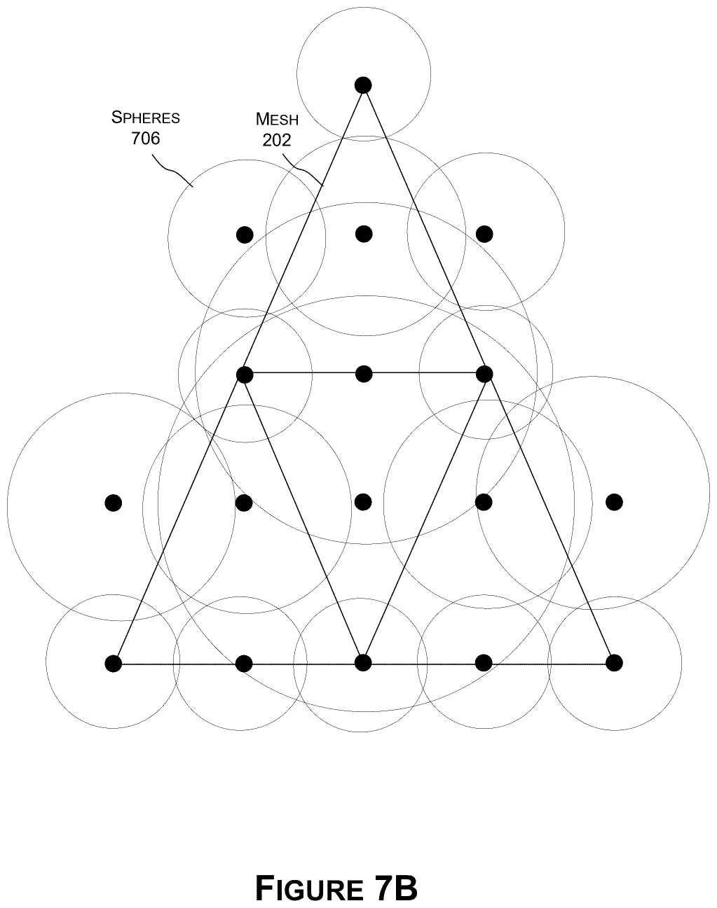

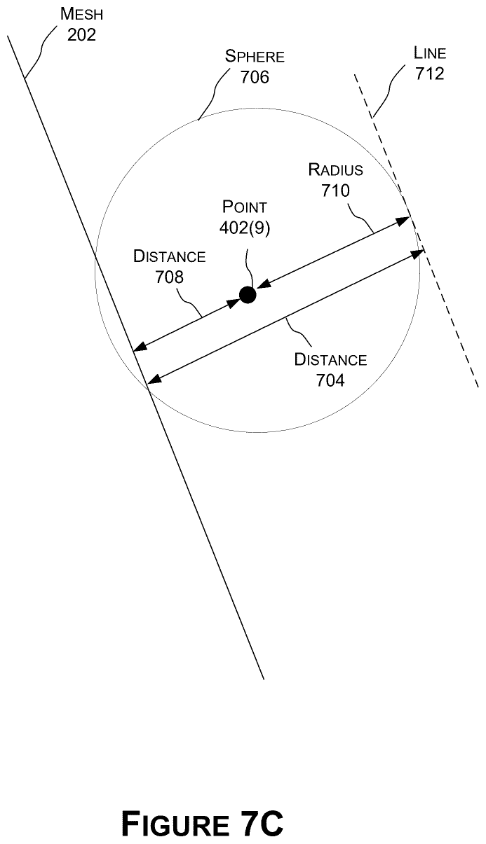

For instance, FIGS. 7A-7C illustrate an example of using the points 402 to generate a candidate set of spheres associated with the mesh 202, in accordance with some embodiments of the present disclosure. As shown by the example of FIG. 7A, and with regard to at least the point 402(10), the sphere component 116 may determine that a distance 702 between the point 402(10) and the mesh 202 is equal to or greater than half an overshoot distance 704. As such, the sphere component 116 may remove the point 402(10) from the initial set of points, which is indicated by the cross. The sphere component 116 may then perform similar processes to determine to remove the points 402(1)-(2), 402(4)-(6), 402(11), and 402(15) from the initial set of points. As such, after the removal, the sphere component 116 may determine a final set of points that includes the remaining points 402.

Next, and as shown in the example of FIG. 7B, the sphere component 116 may determine a candidate set of spheres 706 (although only one is labeled for clarity reasons) using the points 402 included in the final set of points. For instance, and as described herein, for a point 402 that is located inside the mesh 202, the sphere component 116 may determine a sphere 706 as being centered at the point 402 and including a radius that is the distance between the point 402 and the mesh 202 plus the overshoot distance 704. Additionally, for a point 402 that is located outside of the mesh 202, the sphere component 116 may determine a sphere 706 as being centered at the point 402 and including a radius that is the distance between the point 402 and the mesh 202 minus the overshoot distance 704.

For more detail, and as shown by FIG. 7C, the sphere component 116 may determine that a distance 708 between the point 402(9) and the mesh 202 is less than half of the overshoot distance 704. As such, the sphere component 116 may determine a radius 710 for the sphere 706 associated with the point 402(9) as including the overshoot distance 704 subtracted by the distance 708. In some examples, when determining the radius 710, the sphere component 116 may initially determine that the radius 710 satisfies one or more conditions. For example, the sphere component 116 may determine that the sphere 706 is tangent to an overshoot distance line 712 and/or determine the radius 710 such that the radius 710 intersects with at least a portion of the mesh 202.

Referring back to the example of FIG. 1, the process 100 may include using a pruning component 120 to generate a final set of spheres associated with the mesh by removing one or more spheres from the candidate set of spheres. For instance, and as shown, the process 100 may initially include the pruning component 120 using a sampling component 122 to determine a set of points located on a surface of the mesh. In some examples, the sampling component 122 may determine the set of points using sampling, such as by uniformly sampling the surface of the mesh. In some examples, the sampling component 122 may use one or more parameters when determining the set of points, such as a spacing to use between the points, a number of points to include in the set of points, specific locations for placing the points (e.g., on edges between polygons, on vertices between polygons, on surfaces of polygons, etc.), and/or any other parameter. Still, in some examples, the sampling component 122 may then use one or more processes to partition the set of points, such as by partitioning the set of points into one or more data structures. As described herein, a data structure may include, but is not limited to, an octant, a multi-level octree, a denser occupancy map, and/or any other type of data structure.

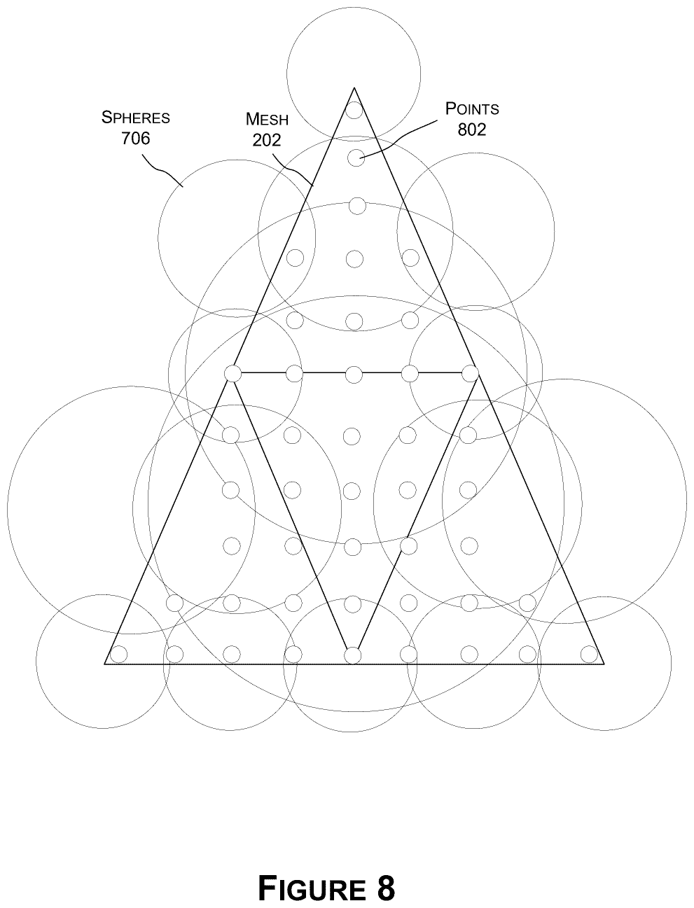

For instance, FIG. 8 illustrates an example of determining points 802 (although only one is labeled for clarity reasons) on a surface of the mesh 202 for pruning a candidate set of spheres associated with the mesh 202, in accordance with some embodiments of the present disclosure. As shown, the sampling component 122 may uniformly distribute the points 802 over the surface of the mesh 202 such that there is even and/or substantially even spacing between the points 802. However, in other examples, the sampling component 122 may distribute the points 802 across the surface of the mesh 202 using any other technique. Additionally, while the example of FIG. 8 illustrates distributing forty-five points 802 across the surface of the mesh 202, in other examples, the sampling component 122 may distribute any other number of points across the surface of the mesh 202.

Referring back to the example of FIG. 1, the process 100 may include the pruning component 120 using a mapping component 124 to generate one or more maps associated with one or more points from the set of points. As described herein, in some examples and for a point, the mapping component 124 may generate a map that indicates one or more (e.g., each) of the spheres that encloses the point. For example, the mapping component 124 may generate a first map that indicates that one or more first spheres enclose a first point, a second map that indicates that one or more second spheres enclose a second point, a third map that indicates that one or more third spheres enclose a third point, and/or so forth. In some examples, such as to reduce the amount of computing resources needed to perform the mapping and/or to reduce the time it takes to perform the mapping, the mapping component 124 may test one or more (e.g., each) of the spheres for overlap with the bounding shape of one or more (e.g., each) of the data structure(s) described above. In some examples, such as to again reduce the time it takes to perform the mapping, the mapping component 124 may determine whether the spheres overlap with the points in parallel.

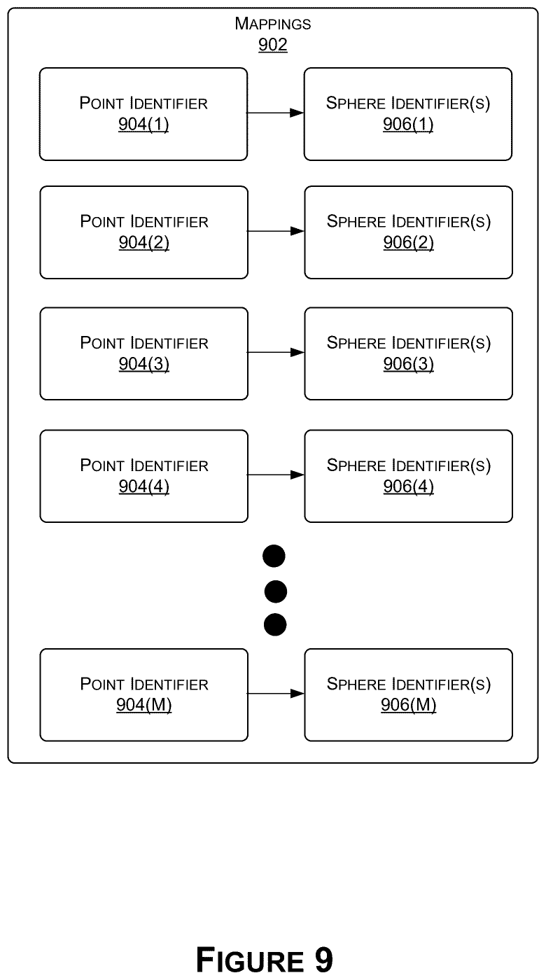

For instance, FIG. 9 illustrates an example of generating mappings 902 associated with the points 802 located on a surface of the mesh 202, in accordance with some embodiments of the present disclosure. As shown, the mappings 902 may associate identifiers 904(1)-(M) associated with the points 802 with identifiers 906(1)-(M) associated with spheres that enclose the points 802. For example, a first map 902 may associate a first identifier 904(1) associated with a first point 802 with one or more first identifiers 906(1) associated with one or more first spheres 706 that enclose the first point 802, a second map 902 may associate a second identifier 904(2) associated with a second point 802 with one or more second identifiers 906(2) associated with one or more second spheres 706 that enclose the second point 802, a third map 902 may associate a third identifier 904(3) associated with a third point 802 with one or more third identifiers 906(3) associated with one or more third spheres 706 that enclose the third point 802, and/or so forth

Referring back to the example of FIG. 1, the process 100 may include the pruning component 120 using a selection component 126 to determine a final set of spheres based at least on the candidate set of spheres and the mappings. For instance, in some examples, the selection component 126 may initially remove one or more spheres from the candidate set of spheres that do not enclose at least one point from the set of points. While the example of FIG. 1 describes performing this removal step after generating the maps, in other examples, the selection component 126 may perform this removal step before generating the maps. For instance, the selection component 126 may perform this removal step after the sampling component 122 determines the set of points located on the surface of the mesh. This way, the mapping component 124 may not consider that removed sphere(s) when generating the maps associated with the points.

The selection component 126 may then determine whether one or more points from the set of points are only enclosed by a single sphere of the candidate set of spheres, such as by using the map(s). If the selection component 126 determines that a point is enclosed by only a single sphere, then the selection component 126 may add that sphere to the final set of spheres. Additionally, the selection component 126 may remove one or more other points from the set of point that are also enclosed by the sphere from consideration for adding and/or removing additional spheres. In some examples, the selection component 126 may perform such processes since, if a point is enclosed by only a single sphere, that sphere may be needed to ensure full coverage of the mesh.

After adding this sphere(s) to the final set of spheres, the selection component 126 may then determine if at least a remaining sphere from the candidate set of spheres encloses one or more points which are also all enclosed by one or more other remaining spheres. If the selection component 126 determines that all of the point(s) enclosed by a remaining sphere are enclosed by at least one other remaining sphere, then the selection component 126 may remove at least that sphere from being included in the final set of spheres. In some examples, the selection component 126 may use one or more factors when removing a sphere. For example, if all of the points enclosed by multiple spheres are also enclosed by other spheres, the selection component 126 may remove the smallest sphere, the largest sphere, the sphere to encloses the least number of points, the sphere that encloses the greatest number of points, the sphere that includes a center located outside of the mesh, the sphere that includes a center that is located inside of the mesh, and/or any other sphere.

In some examples, the selection component 126 may continue to perform these processes of adding one or more spheres for which one or more points are only enclosed by and/or removing one or more spheres for which multiple points are enclosed by for one or more iterations. For example, the selection component 126 may continue to perform these processes until all surface points are covered by one or more spheres, there are no more spheres left for consideration (e.g., all the spheres have either been added to the final set of spheres or removed), a set number of iterations has been performed (e.g., one iteration, five iterations, ten iterations, fifty iterations, etc.), and/or any other event occurs. In some examples, after performing these processes, if one or more points still exist for which one or more spheres from the final set of spheres does not enclose, the selection component 126 may then generate one or more new spheres to add to the final set of spheres. For example, and for a point, the selection component 126 may add a new sphere that is centered at the point and has a radius that includes the overshoot distance.

The process 100 may then include generating and/or outputting sphere data 128 representing the final set of spheres associated with the mesh and/or the object. For instance, the sphere data 128 may represent one or more identifiers for one or more spheres included in the final set of spheres, one or more locations associated with the sphere(s), one or more sizes (e.g., one or more radiuses) associated with the sphere(s), and/or any other information associated with the sphere(s). The process 100 may then include one or more processing components 130 performing one or more processes using the final set of spheres represented by the sphere data 128. For a first example, a processing component 130 may store the sphere data 128 representing the final set of spheres in association with the mesh and/or the object. For a second example, a processing component 130 may use the final set of spheres when determining one or more operations that the object is to perform. For instance, the processing component 130 may use the final set of spheres to determine whether the object may collide with another object when performing trajectory optimization, sampling-based planning, reactive motion control, collision-aware inverse kinematics, and/or any other type of control associated with the object.

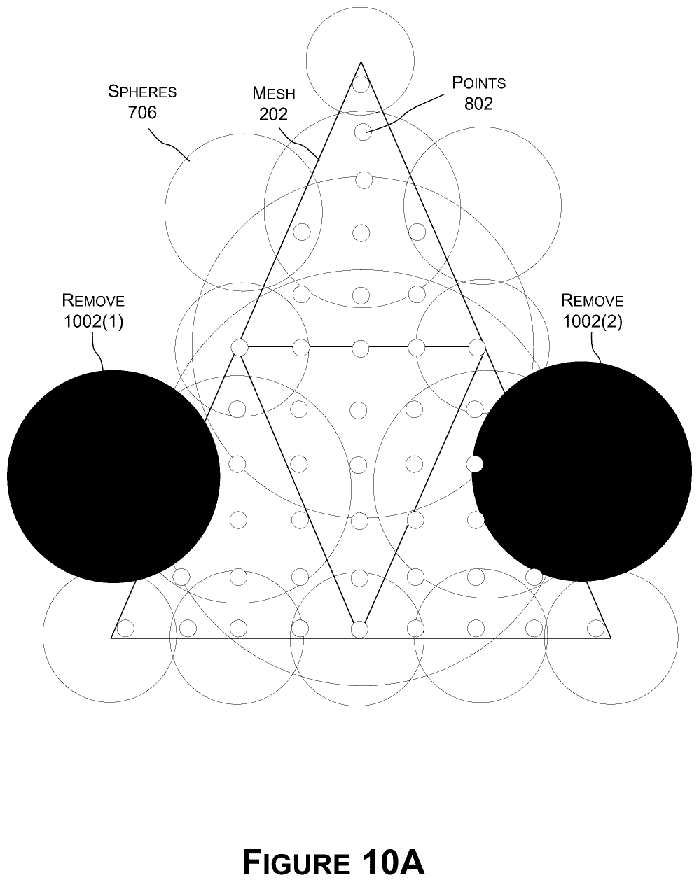

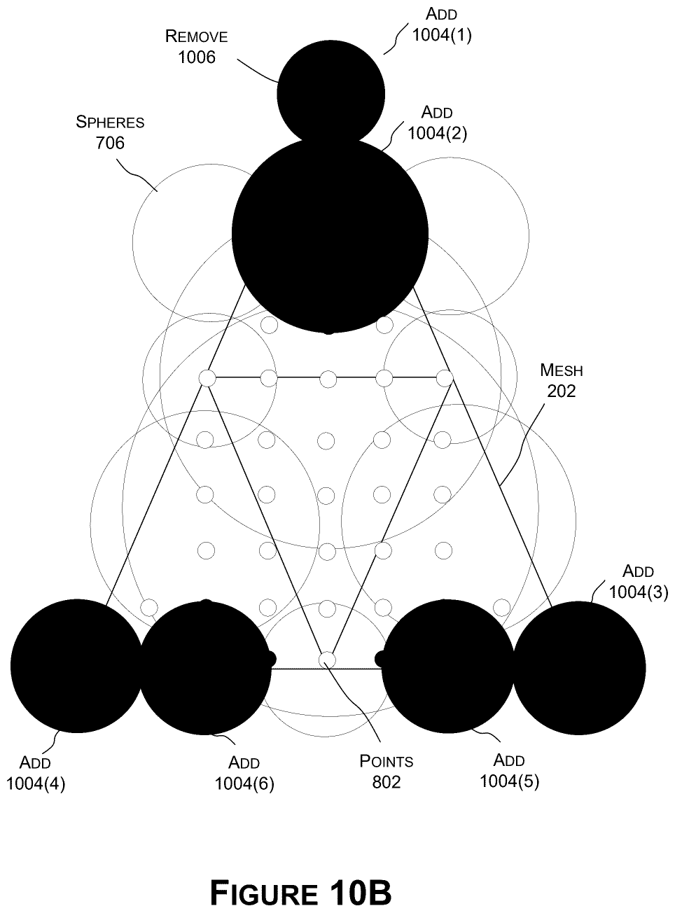

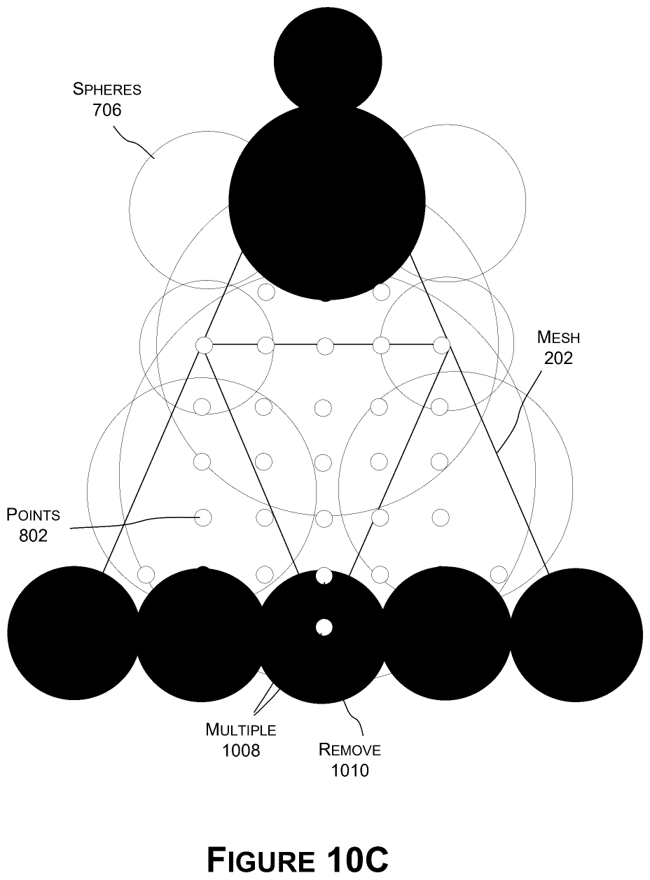

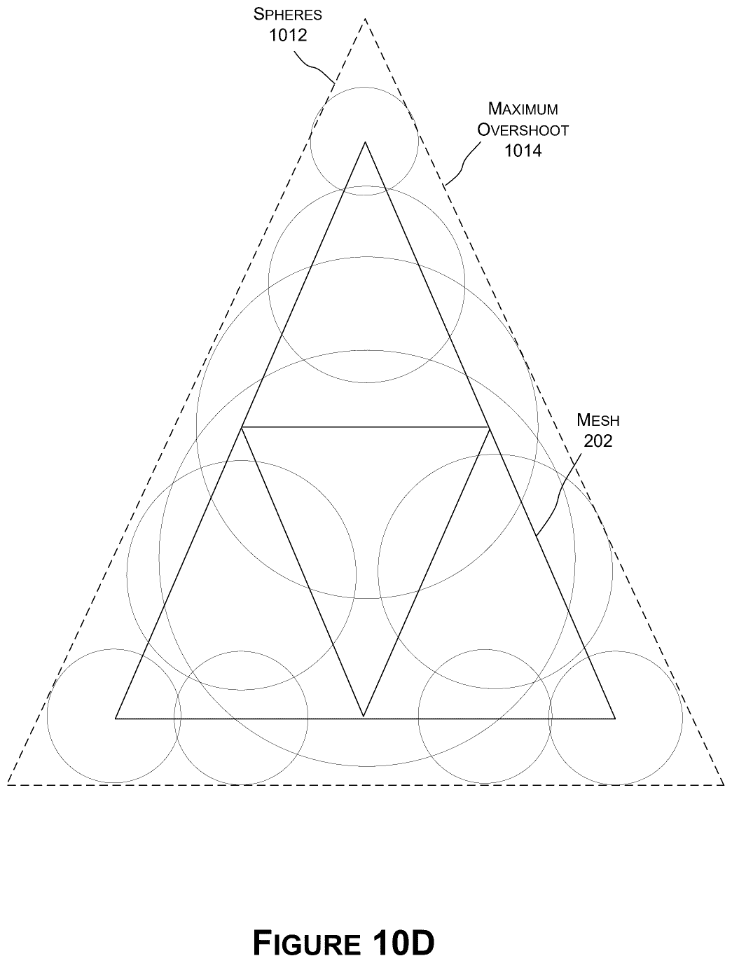

For instance, FIGS. 10A-10D illustrate an example of selecting candidate spheres for inclusion in a final set of spheres, in accordance with some embodiments of the present disclosure. As shown by the example of FIG. 10A, the selection component 126 may initially remove spheres 706 from the candidate set of spheres that do not enclose any of the points 802. For instance, the selection component 126 may remove two spheres 706, which is indicated by removals 1002(1)-(2) and dark shading. As described herein, the selection component 126 may remove these spheres 706 since these spheres 706 may not be needed for full coverage of the surface of the mesh 202.

Next, and as illustrated by the example of FIG. 10B, the selection component 126 may identity points 802 that are enclosed by only a single sphere 802. The selection component 126 may then add these spheres to the final set of spheres, which is indicated by additions 1004(1)-(6) and grey shading. As described herein, the selection component 126 may add these spheres 706 since these spheres 706 may be needed for full coverage of the surface of the mesh 202. Additionally, and as further shown, the selection component 126 may remove one or more additional points 802 that are also enclosed within these spheres 706 from consideration for further adding and/or removing spheres 706, which is indicated by removal 1006 (although only one is labeled for clarity reasons) and solid circles.

Next, and as illustrated by the example of FIG. 10C, the selection component 126 may identify at least a sphere 706 that encloses one or more points that are all enclosed by at least one other sphere 706. The selection component 126 may then remove at least that sphere 706 from the candidate set of spheres, using one or more of the techniques described herein. For instance, and as shown, the selection component 126 may determine that the points 802 that are indicated by multiple 1008 are enclosed both by the sphere that is indicated by dark shading along with at least one other sphere 706. As such, the selection component 126 may remove a sphere 706, such as the smallest sphere 706, which is indicated by removal 1010 and the dark shading. While the example of FIG. 10C only illustrates removing one sphere 706, in other examples, the selection component 126 may perform similar processes to remove more than one of the spheres 706.

As described herein, in some examples, the selection component 126 may then continue to perform these processes illustrated in the example of FIGS. 10A-10C in order to continue adding and/or removing spheres 706. For example, the selection component 126 may continue to perform these processes until all surface points 802 are covered by one or more spheres 706, there are no more spheres 706 left for consideration (e.g., all the spheres 706 have either been added to the final set of spheres or removed), a set number of iterations has been performed (e.g., one iteration, five iterations, ten iterations, fifty iterations, etc.), and/or any other event occurs. After performing such processes, and as illustrated in FIG. 10D, the selection component 126 may determine a final set of spheres 1012 (although only one is labeled for clarity reasons) associated with the mesh 202.

As further illustrated in the example of FIG. 10D, by performing the processes described herein, the final set of spheres 1012 may not extend past a maximum overshoot 1014 associated with the mesh 202. As such, at least a portion of the spheres 1012 may be tangent to the maximum overshoot 1014 and/or at least a portion of the spheres 1012 may be located within the maximum overshoot 1014.

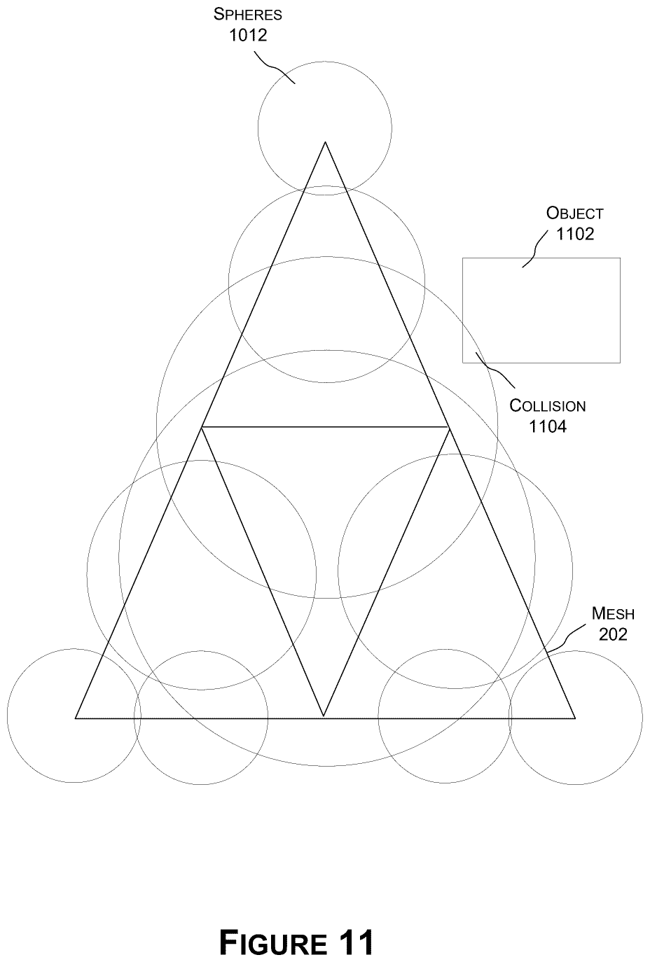

FIG. 11 illustrates an example of using the final set of spheres 1012 to determine whether an object may be in contact (collision) with another object 1102, in accordance with some embodiments of the present disclosure. As shown, the processing component 130 may perform a collision check using the final set of spheres 1012 in order to determine when there is a potential collision with the other object 1102. For instance, the processing component 130 may determine that a potential collision 1104 exists based at least on a portion of at least one of the spheres 1012 overlapping with at least a portion of the other object 1102. While the example of FIG. 11 illustrates the other object 1102 as including another shape, such as a cuboid, in other examples, similar processes may be performed with regard to any other type of object.

As described herein, one or more users may be able to select the overshoot distance associated with how far spheres are able to extend past the mesh 202. In some examples, the larger the overshoot distance, the fewer the number of spheres that may be included within the final set of spheres associated with the mesh 202 since individual spheres are able to cover more volume of the surface of the mesh 202. However, the spheres may also represent a larger amount of volume surrounding the mesh 202 that is not actually part of the mesh 202. Additionally, the smaller the overshoot distance, the greater the number of spheres that may be included within the final set of spheres associated with the mesh 202 since individual spheres cover less volume of the surface of the mesh 202. However, the spheres may also cover a smaller amount of volume surrounding the mesh 202 that is not actually part of the mesh 202.

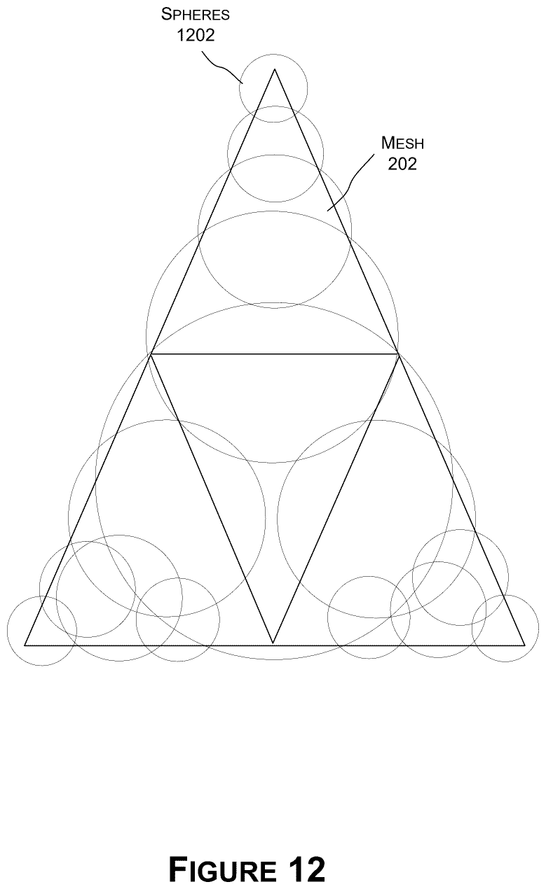

For instance, FIG. 12 illustrates an example of a final set of spheres 1202 associated with the mesh 202, where the final set of spheres 1202 is generated using a smaller overshoot distance as compared to the final set of spheres from the example of FIG. 10D, in accordance with some embodiments of the present disclosure. As shown, similar processes may be performed with respect to the examples of FIGS. 2-10D to determine the final set of spheres 1202 associated with the mesh 202, but with using a smaller overshoot distance. As such, the number of spheres included in the final set of spheres 1202 associated with the example of FIG. 12 may be greater than the number of spheres included in the final set of spheres 1012 associated with the example of FIG. 10D. However, the distances for which the spheres included in the final set of spheres 1202 associated with the example of FIG. 12 extend past the mesh 202 is less than the distances for which the spheres included in the final set of spheres 1012 associated with the example of FIG. 10D extend past the mesh 202.

Referring back to the example of FIG. 1, and as described herein, by using the overshoot distance to ensure that the final set of spheres extend past the surface of the mesh 202, the final set of spheres may be used when computing a point at which the object may collide with another object, such as to avoid such collisions. However, in some examples, a determination may want to be made as to when the object is actually in contact with another object, such as when the object includes a gripper (and/or other object) that is configured to pick one or more other objects up. As such, and as indicated by the dashed arrow, the candidate component 102 may use the final set of spheres represented by the sphere data 128 (and/or perform one or more of these processes to generate a new set of spheres) to make such determinations.

For instance, the sphere component 116 may initially remove one or more (e.g., each) of the spheres from the final set of spheres that include one or more center points that are located outside of the mesh. The sphere component 116 may then determine updated radiuses for the remining spheres from the final set of spheres. In some examples, the sphere component 116 may determine the updated radiuses by subtracting the overshoot distance along with an inset distance from the radiuses of the spheres, where the inset distance may also be represented by distance data 118. By performing such subtractions, and since these spheres include centers that are located within the mesh, the updated spheres may not extend past the surface of the mesh. For instance, if the inset distance is five centimeters, then the spheres may extend at most within five centimeters within the surface of the mesh. The candidate component 102 may then generate and/or output updated sphere data 128 that represents an updated set of spheres. As described herein, since the updated set of spheres do not extend past the surface of the mesh, if a collision check indicates that one of the updated spheres is in contact with another object, then the mesh and/or the object should also be in contact with the other object.

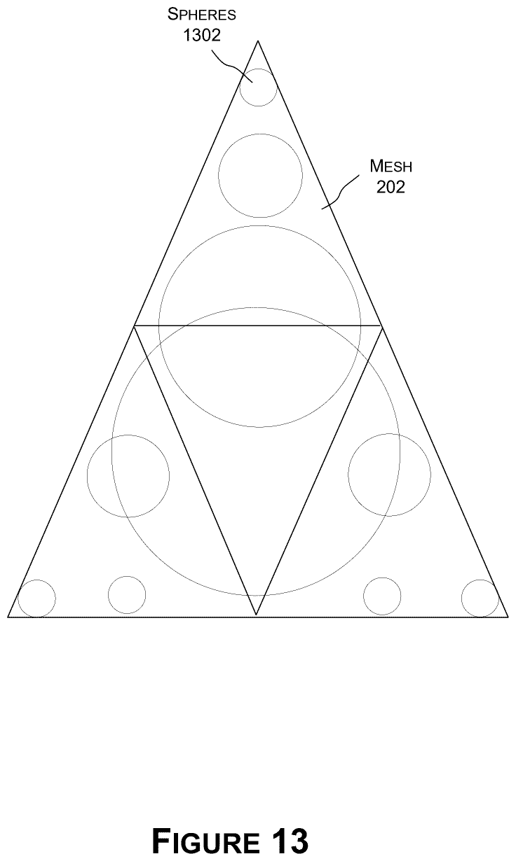

For instance, FIG. 13 illustrates an example of determining a set of spheres 1302 associated with detecting actual contact with the mesh 202, in accordance with some embodiments of the present disclosure. As shown, by determining updated radiuses for the final set of spheres 1012 that include the radiuses of the spheres minus both the overshoot distance and an inset distance, the set of spheres 1302 do not extend past the surface of the mesh 202. As such, if the set of spheres 1302 is used to perform a collision check with regard to the mesh 202, if at least one of the spheres 1302 is found to be in contact with another object, then the mesh 202 and/or the object should also be in contact with that other object. While the example of FIG. 13 illustrates the set of spheres 1302 as not completely covering the surface of the mesh 202, in other examples, the set of spheres 1302 may include additional spheres such that the set of spheres 1302 does cover an entirety of the surface of the mesh 202.

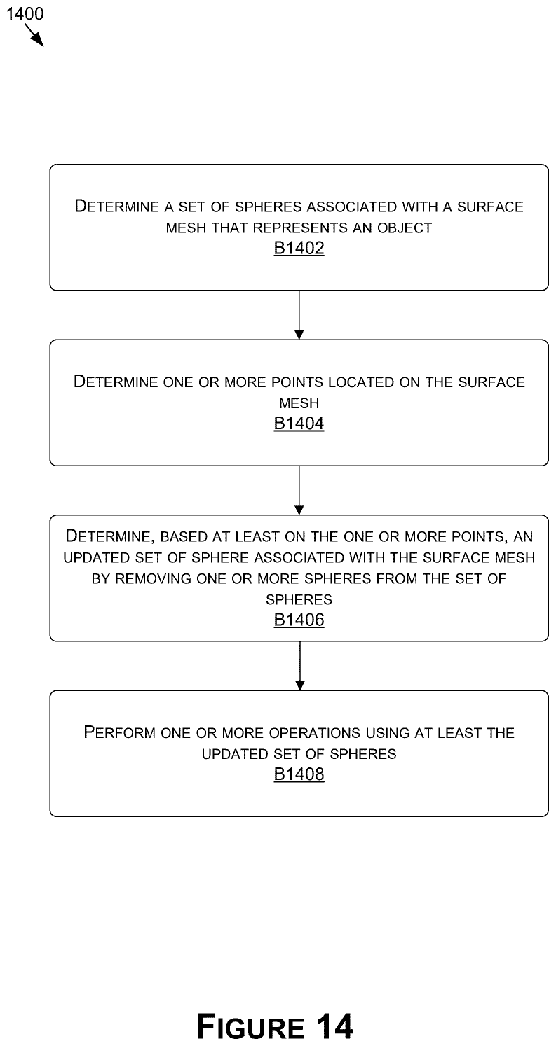

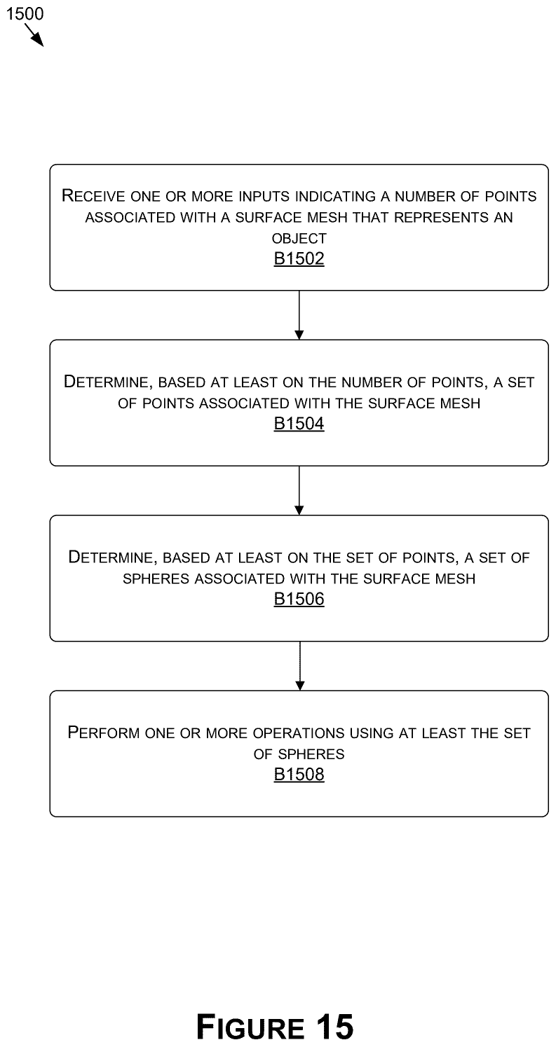

Now referring to FIGS. 14 and 15, each block of methods 1400 and 1500, described herein, comprises a computing process that may be performed using any combination of hardware, firmware, and/or software. For instance, various functions may be carried out by a processor executing instructions stored in memory. The methods 1400 and 1500 may also be embodied as computer-usable instructions stored on computer storage media. The methods 1400 and 1500 may be provided by a standalone application, a service or hosted service (standalone or in combination with another hosted service), or a plug-in to another product, to name a few. In addition, the methods 1400 and 1500 are described, by way of example, with respect to FIG. 1. However, these methods 1400 and 1500 may additionally or alternatively be executed by any one system, or any combination of systems, including, but not limited to, those described herein.

FIG. 14 illustrates a flow diagram showing a method 1400 for determining collision spheres associated with an object, in accordance with some embodiments of the present disclosure. The method 1400, at block B1402, may include determining a set of spheres associated with a surface mesh that represents an object. For instance, the candidate component 102 may perform one or more of the processes described herein to determine the set of spheres associated with the mesh, where the set of spheres may correspond to a candidate set of spheres. For example, the candidate component 102 may determine a bounding shape associated with the mesh, determine points within the bounding shape, classify the points as being located inside of the mesh or outside of the mesh, determine distances between the points and the mesh, and then use the classifications, the distances, and/or an overshoot distance to generate the set of spheres.

The method 1400, at block B1404, may include determining one or more points located on the surface mesh. For instance, the pruning component 120 (e.g., the sampling component 122) may determine the point(s) located on the surface of the mesh. As described herein, in some examples, the pruning component 120 may determine the point(s) based at least on performing one or more sampling techniques.

The method 1400, at block B1406, may include determining, based at least on the one or more points, an updated set of spheres associated with the surface mesh by removing one or more spheres from the set of spheres. For instance, the pruning component 120 (e.g., the selection component 126) may perform one or more of the processes described herein to determine the updated set of spheres using the set of spheres and the point(s), where the updated set of spheres may correspond to the final set of spheres. For example, the pruning component 120 may generate maps that associate the point(s) with the spheres that enclose the point(s), add one or more spheres for which one or more points are only enclosed, remove one or more spheres for which one or more points are enclosed by multiple spheres, and/or using any other technique.

The method 1400, at block B1408, may include performing one or more operations using at least the updated set of spheres. For instance, the processing component(s) 130 may use the sphere data 128 representing the updated set of spheres to perform the operation(s). For a first example, the processing component(s) 130 may store the sphere data 128 in association with the mesh and/or the object. For a second example, the processing component(s) 130 may use the sphere data 128 to determine whether the object may collide with another object when performing trajectory optimization, sampling-based planning, reactive motion control, collision-aware inverse kinematics, and/or any other type of control associated with the object.

FIG. 15 illustrates a flow diagram showing a method 1500 for determining collision spheres associated with an object, in accordance with some embodiments of the present disclosure. The method 1500, at block B1502, may include receiving one or more inputs indicating a number of points associated with a surface mesh that represents an object. For instance, the candidate component 102 may receive input data representing the input(s) from a user, where the input(s) may indicate the number of points. The candidate component 102 may then store the input data as the points data 110 and/or may generate the points data 110 to also indicate the number of points.

The method 1500, at block B1504, may include determining, based at least on the number of points, a set of points associated with the surface mesh. For instance, the candidate component 102 (e.g., the bounding component 106) may initially determine a bounding shape that at least partially encloses the mesh. The candidate component 102 (e.g., the points component 108) may then determine the set of points located within the bounding shape such that the set of points includes the number of points. As described herein, the candidate component 102 may determine the locations of the points using one or more techniques that cause the points to be optimized with respect to the mesh and/or the bounding shape. For instance, in some examples, the candidate component 102 may determine the locations of the points using a grid pattern, where the grid is arranged such that there is a two-dimensional grid of points at one or more (e.g., each) of the planes of the bounding shape.

The method 1500, at block B1506, may include determining, based at least on the set of points, a set of spheres associated with the surface mesh. For instance, the candidate component 102 (e.g., classification component 112) may initially classify the points as being located within the mesh and/or outside of the mesh. The candidate component 102 (e.g., the distance component 114) may then determine distances between the points and the mesh. Additionally, the candidate component 102 (e.g., the sphere component 116) may then use the set of points, the classifications, the distances, and/or an overshoot distance to determine a candidate set of spheres. In some examples, the pruning component 120 may then determine a final set of spheres using the candidate set of spheres.

The method 1500, at block B1508, may include performing one or more operations using at least the set of spheres. For instance, the processing component(s) 130 may use the sphere data 128 representing the final set of spheres to perform the operation(s). For a first example, the processing component(s) 130 may store the sphere data 128 in association with the mesh and/or the object. For a second example, the processing component(s) 130 may use the sphere data 128 to determine whether the object may collide with another object when performing trajectory optimization, sampling-based planning, reactive motion control, collision-aware inverse kinematics, and/or any other type of control associated with the object.

### Example Autonomous Vehicle

FIG. 16A is an illustration of an example autonomous vehicle 1600, in accordance with some embodiments of the present disclosure. The autonomous vehicle 1600 (alternatively referred to herein as the “vehicle 1600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1600 may be capable of functionality in accordance with one or more of Level 3-Level 5 of the autonomous driving levels. The vehicle 1600 may be capable of functionality in accordance with one or more of Level 1-Level 5 of the autonomous driving levels. For example, the vehicle 1600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1600 or other machine, such as being fully autonomous, being highly autonomous, being conditionally autonomous, being partially autonomous, providing assistive autonomy, being semi-autonomous, being primarily autonomous, or other designation.

The vehicle 1600 may include components such as a chassis, a vehicle body, wheels (e.g., 2, 4, 6, 8, 18, etc.), tires, axles, and other components of a vehicle. The vehicle 1600 may include a propulsion system 1650, such as an internal combustion engine, hybrid electric power plant, an all-electric engine, and/or another propulsion system type. The propulsion system 1650 may be connected to a drive train of the vehicle 1600, which may include a transmission, to enable the propulsion of the vehicle 1600. The propulsion system 1650 may be controlled in response to receiving signals from the throttle/accelerator 1652.

A steering system 1654, which may include a steering wheel, may be used to steer the vehicle 1600 (e.g., along a desired path or route) when the propulsion system 1650 is operating (e.g., when the vehicle is in motion). The steering system 1654 may receive signals from a steering actuator 1656. The steering wheel may be optional for full automation (Level 5) functionality.

The brake sensor system 1646 may be used to operate the vehicle brakes in response to receiving signals from the brake actuators 1648 and/or brake sensors.

Controller(s) 1636, which may include one or more system on chips (SoCs) 1604 (FIG. 16C) and/or GPU(s), may provide signals (e.g., representative of commands) to one or more components and/or systems of the vehicle 1600. For example, the controller(s) may send signals to operate the vehicle brakes via one or more brake actuators 1648, to operate the steering system 1654 via one or more steering actuators 1656, to operate the propulsion system 1650 via one or more throttle/accelerators 1652. The controller(s) 1636 may include one or more onboard (e.g., integrated) computing devices (e.g., supercomputers) that process sensor signals, and output operation commands (e.g., signals representing commands) to enable autonomous driving and/or to assist a human driver in driving the vehicle 1600. The controller(s) 1636 may include a first controller 1636 for autonomous driving functions, a second controller 1636 for functional safety functions, a third controller 1636 for artificial intelligence functionality (e.g., computer vision), a fourth controller 1636 for infotainment functionality, a fifth controller 1636 for redundancy in emergency conditions, and/or other controllers. In some examples, a single controller 1636 may handle two or more of the above functionalities, two or more controllers 1636 may handle a single functionality, and/or any combination thereof.

The controller(s) 1636 may provide the signals for controlling one or more components and/or systems of the vehicle 1600 in response to sensor data received from one or more sensors (e.g., sensor inputs). The sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LIDAR sensor(s) 1664, inertial measurement unit (IMU) sensor(s) 1666 (e.g., accelerometer(s), gyroscope(s), magnetic compass(es), magnetometer(s), etc.), microphone(s) 1696, stereo camera(s) 1668, wide-view camera(s) 1670 (e.g., fisheye cameras), infrared camera(s) 1672, surround camera(s) 1674 (e.g., 360 degree cameras), long-range and/or mid-range camera(s) 1698, speed sensor(s) 1644 (e.g., for measuring the speed of the vehicle 1600), vibration sensor(s) 1642, steering sensor(s) 1640, brake sensor(s) (e.g., as part of the brake sensor system 1646), and/or other sensor types.

One or more of the controller(s) 1636 may receive inputs (e.g., represented by input data) from an instrument cluster 1632 of the vehicle 1600 and provide outputs (e.g., represented by output data, display data, etc.) via a human-machine interface (HMI) display 1634, an audible annunciator, a loudspeaker, and/or via other components of the vehicle 1600. The outputs may include information such as vehicle velocity, speed, time, map data (e.g., the High Definition (“HD”) map 1622 of FIG. 16C), location data (e.g., the vehicle's 1600 location, such as on a map), direction, location of other vehicles (e.g., an occupancy grid), information about objects and status of objects as perceived by the controller(s) 1636, etc. For example, the HMI display 1634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1600 further includes a network interface 1624 which may use one or more wireless antenna(s) 1626 and/or modem(s) to communicate over one or more networks. For example, the network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 16B is an example of camera locations and fields of view for the example autonomous vehicle 1600 of FIG. 16A, in accordance with some embodiments of the present disclosure. The cameras and respective fields of view are one example embodiment and are not intended to be limiting. For example, additional and/or alternative cameras may be included and/or the cameras may be located at different locations on the vehicle 1600.

The camera types for the cameras may include, but are not limited to, digital cameras that may be adapted for use with the components and/or systems of the vehicle 1600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1600 (e.g., front-facing cameras) may be used for surround view, to help identify forward facing paths and obstacles, as well aid in, with the help of one or more controllers 1636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1670 that may be used to perceive objects coming into view from the periphery (e.g., pedestrians, crossing traffic or bicycles). Although only one wide-view camera is illustrated in FIG. 16B, there may be any number (including zero) of wide-view cameras 1670 on the vehicle 1600. In addition, any number of long-range camera(s) 1698 (e.g., a long-view stereo camera pair) may be used for depth-based object detection, especially for objects for which a neural network has not yet been trained. The long-range camera(s) 1698 may also be used for object detection and classification, as well as basic object tracking.

Any number of stereo cameras 1668 may also be included in a front-facing configuration. In at least one embodiment, one or more of stereo camera(s) 1668 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1668 may be used in addition to, or alternatively from, those described herein.

Cameras with a field of view that include portions of the environment to the side of the vehicle 1600 (e.g., side-view cameras) may be used for surround view, providing information used to create and update the occupancy grid, as well as to generate side impact collision warnings. For example, surround camera(s) 1674 (e.g., four surround cameras 1674 as illustrated in FIG. 16B) may be positioned to on the vehicle 1600. The surround camera(s) 1674 may include wide-view camera(s) 1670, fisheye camera(s), 360 degree camera(s), and/or the like. Four example, four fisheye cameras may be positioned on the vehicle's front, rear, and sides. In an alternative arrangement, the vehicle may use three surround camera(s) 1674 (e.g., left, right, and rear), and may leverage one or more other camera(s) (e.g., a forward-facing camera) as a fourth surround view camera.

Cameras with a field of view that include portions of the environment to the rear of the vehicle 1600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1698, stereo camera(s) 1668), infrared camera(s) 1672, etc.), as described herein.

FIG. 16C is a block diagram of an example system architecture for the example autonomous vehicle 1600 of FIG. 16A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1600 in FIG. 16C are illustrated as being connected via bus 1602. The bus 1602 may include a Controller Area Network (CAN) data interface (alternatively referred to herein as a “CAN bus”). A CAN may be a network inside the vehicle 1600 used to aid in control of various features and functionality of the vehicle 1600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1602 is described herein as being a CAN bus, this is not intended to be limiting. For example, in addition to, or alternatively from, the CAN bus, FlexRay and/or Ethernet may be used. Additionally, although a single line is used to represent the bus 1602, this is not intended to be limiting. For example, there may be any number of busses 1602, which may include one or more CAN busses, one or more FlexRay busses, one or more Ethernet busses, and/or one or more other types of busses using a different protocol. In some examples, two or more busses 1602 may be used to perform different functions, and/or may be used for redundancy. For example, a first bus 1602 may be used for collision avoidance functionality and a second bus 1602 may be used for actuation control. In any example, each bus 1602 may communicate with any of the components of the vehicle 1600, and two or more busses 1602 may communicate with the same components. In some examples, each SoC 1604, each controller 1636, and/or each computer within the vehicle may have access to the same input data (e.g., inputs from sensors of the vehicle 1600), and may be connected to a common bus, such the CAN bus.

The vehicle 1600 may include one or more controller(s) 1636, such as those described herein with respect to FIG. 16A. The controller(s) 1636 may be used for a variety of functions. The controller(s) 1636 may be coupled to any of the various other components and systems of the vehicle 1600, and may be used for control of the vehicle 1600, artificial intelligence of the vehicle 1600, infotainment for the vehicle 1600, and/or the like.

The vehicle 1600 may include a system(s) on a chip (SoC) 1604. The SoC 1604 may include CPU(s) 1606, GPU(s) 1608, processor(s) 1610, cache(s) 1612, accelerator(s) 1614, data store(s) 1616, and/or other components and features not illustrated. The SoC(s) 1604 may be used to control the vehicle 1600 in a variety of platforms and systems. For example, the SoC(s) 1604 may be combined in a system (e.g., the system of the vehicle 1600) with an HD map 1622 which may obtain map refreshes and/or updates via a network interface 1624 from one or more servers (e.g., server(s) 1678 of FIG. 16D).

The CPU(s) 1606 may include a CPU cluster or CPU complex (alternatively referred to herein as a “CCPLEX”). The CPU(s) 1606 may include multiple cores and/or L2 caches. For example, in some embodiments, the CPU(s) 1606 may include eight cores in a coherent multi-processor configuration. In some embodiments, the CPU(s) 1606 may include four dual-core clusters where each cluster has a dedicated L2 cache (e.g., a 2 MB L2 cache). The CPU(s) 1606 (e.g., the CCPLEX) may be configured to support simultaneous cluster operation enabling any combination of the clusters of the CPU(s) 1606 to be active at any given time.

The CPU(s) 1606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1608 may include an integrated GPU (alternatively referred to herein as an “iGPU”). The GPU(s) 1608 may be programmable and may be efficient for parallel workloads. The GPU(s) 1608, in some examples, may use an enhanced tensor instruction set. The GPU(s) 1608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1608 may include at least eight streaming microprocessors. The GPU(s) 1608 may use compute application programming interface(s) (API(s)). In addition, the GPU(s) 1608 may use one or more parallel computing platforms and/or programming models (e.g., NVIDIA's CUDA).

The GPU(s) 1608 may be power-optimized for best performance in automotive and embedded use cases. For example, the GPU(s) 1608 may be fabricated on a Fin field-effect transistor (FinFET). However, this is not intended to be limiting and the GPU(s) 1608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1608 to access the CPU(s) 1606 page tables directly. In such examples, when the GPU(s) 1608 memory management unit (MMU) experiences a miss, an address translation request may be transmitted to the CPU(s) 1606. In response, the CPU(s) 1606 may look in its page tables for the virtual-to-physical mapping for the address and transmits the translation back to the GPU(s) 1608. As such, unified memory technology may allow a single unified virtual address space for memory of both the CPU(s) 1606 and the GPU(s) 1608, thereby simplifying the GPU(s) 1608 programming and porting of applications to the GPU(s) 1608.

In addition, the GPU(s) 1608 may include an access counter that may keep track of the frequency of access of the GPU(s) 1608 to memory of other processors. The access counter may help ensure that memory pages are moved to the physical memory of the processor that is accessing the pages most frequently.

The SoC(s) 1604 may include any number of cache(s) 1612, including those described herein. For example, the cache(s) 1612 may include an L3 cache that is available to both the CPU(s) 1606 and the GPU(s) 1608 (e.g., that is connected both the CPU(s) 1606 and the GPU(s) 1608). The cache(s) 1612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1604 may include an arithmetic logic unit(s) (ALU(s)) which may be leveraged in performing processing with respect to any of the variety of tasks or operations of the vehicle 1600—such as processing DNNs. In addition, the SoC(s) 1604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1606 and/or GPU(s) 1608.

The SoC(s) 1604 may include one or more accelerators 1614 (e.g., hardware accelerators, software accelerators, or a combination thereof). For example, the SoC(s) 1604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1608 and to off-load some of the tasks of the GPU(s) 1608 (e.g., to free up more cycles of the GPU(s) 1608 for performing other tasks). As an example, the accelerator(s) 1614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1608, and by using an inference accelerator, for example, a designer may target either the DLA(s) or the GPU(s) 1608 for any function. For example, the designer may focus processing of CNNs and floating point operations on the DLA(s) and leave other functions to the GPU(s) 1608 and/or other accelerator(s) 1614.

The accelerator(s) 1614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1614 (e.g., the hardware acceleration cluster) may include a computer vision network on-chip and SRAM, for providing a high-bandwidth, low latency SRAM for the accelerator(s) 1614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1666 output that correlates with the vehicle 1600 orientation, distance, 3D location estimates of the object obtained from the neural network and/or other sensors (e.g., LIDAR sensor(s) 1664 or RADAR sensor(s) 1660), among others.

The SoC(s) 1604 may include data store(s) 1616 (e.g., memory). The data store(s) 1616 may be on-chip memory of the SoC(s) 1604, which may store neural networks to be executed on the GPU and/or the DLA. In some examples, the data store(s) 1616 may be large enough in capacity to store multiple instances of neural networks for redundancy and safety. The data store(s) 1612 may comprise L2 or L3 cache(s) 1612. Reference to the data store(s) 1616 may include reference to the memory associated with the PVA, DLA, and/or other accelerator(s) 1614, as described herein.

The SoC(s) 1604 may include one or more processor(s) 1610 (e.g., embedded processors). The processor(s) 1610 may include a boot and power management processor that may be a dedicated processor and subsystem to handle boot power and management functions and related security enforcement. The boot and power management processor may be a part of the SoC(s) 1604 boot sequence and may provide runtime power management services. The boot power and management processor may provide clock and voltage programming, assistance in system low power state transitions, management of SoC(s) 1604 thermals and temperature sensors, and/or management of the SoC(s) 1604 power states. Each temperature sensor may be implemented as a ring-oscillator whose output frequency is proportional to temperature, and the SoC(s) 1604 may use the ring-oscillators to detect temperatures of the CPU(s) 1606, GPU(s) 1608, and/or accelerator(s) 1614. If temperatures are determined to exceed a threshold, the boot and power management processor may enter a temperature fault routine and put the SoC(s) 1604 into a lower power state and/or put the vehicle 1600 into a chauffeur to safe stop mode (e.g., bring the vehicle 1600 to a safe stop).

The processor(s) 1610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1610 may further include a real-time camera engine that may include a dedicated processor subsystem for handling real-time camera management.

The processor(s) 1610 may further include a high-dynamic range signal processor that may include an image signal processor that is a hardware engine that is part of the camera processing pipeline.

The processor(s) 1610 may include a video image compositor that may be a processing block (e.g., implemented on a microprocessor) that implements video post-processing functions needed by a video playback application to produce the final image for the player window. The video image compositor may perform lens distortion correction on wide-view camera(s) 1670, surround camera(s) 1674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1608 is not required to continuously render new surfaces. Even when the GPU(s) 1608 is powered on and active doing 3D rendering, the video image compositor may be used to offload the GPU(s) 1608 to improve performance and responsiveness.

The SoC(s) 1604 may further include a mobile industry processor interface (MIPI) camera serial interface for receiving video and input from cameras, a high-speed interface, and/or a video input block that may be used for camera and related pixel input functions. The SoC(s) 1604 may further include an input/output controller(s) that may be controlled by software and may be used for receiving I/O signals that are uncommitted to a specific role.

The SoC(s) 1604 may further include a broad range of peripheral interfaces to enable communication with peripherals, audio codecs, power management, and/or other devices. The SoC(s) 1604 may be used to process data from cameras (e.g., connected over Gigabit Multimedia Serial Link and Ethernet), sensors (e.g., LIDAR sensor(s) 1664, RADAR sensor(s) 1660, etc. that may be connected over Ethernet), data from bus 1602 (e.g., speed of vehicle 1600, steering wheel position, etc.), data from GNSS sensor(s) 1658 (e.g., connected over Ethernet or CAN bus). The SoC(s) 1604 may further include dedicated high-performance mass storage controllers that may include their own DMA engines, and that may be used to free the CPU(s) 1606 from routine data management tasks.

The SoC(s) 1604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1604 may be faster, more reliable, and even more energy-efficient and space-efficient than conventional systems. For example, the accelerator(s) 1614, when combined with the CPU(s) 1606, the GPU(s) 1608, and the data store(s) 1616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1608.

In some examples, a CNN for facial recognition and vehicle owner identification may use data from camera sensors to identify the presence of an authorized driver and/or owner of the vehicle 1600. The always on sensor processing engine may be used to unlock the vehicle when the owner approaches the driver door and turn on the lights, and, in security mode, to disable the vehicle when the owner leaves the vehicle. In this way, the SoC(s) 1604 provide for security against theft and/or carjacking.

In another example, a CNN for emergency vehicle detection and identification may use data from microphones 1696 to detect and identify emergency vehicle sirens. In contrast to conventional systems, that use general classifiers to detect sirens and manually extract features, the SoC(s) 1604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1662, until the emergency vehicle(s) passes.

The vehicle may include a CPU(s) 1618 (e.g., discrete CPU(s), or dCPU(s)), that may be coupled to the SoC(s) 1604 via a high-speed interconnect (e.g., PCIe). The CPU(s) 1618 may include an X86 processor, for example. The CPU(s) 1618 may be used to perform any of a variety of functions, including arbitrating potentially inconsistent results between ADAS sensors and the SoC(s) 1604, and/or monitoring the status and health of the controller(s) 1636 and/or infotainment SoC 1630, for example.

The vehicle 1600 may include a GPU(s) 1620 (e.g., discrete GPU(s), or dGPU(s)), that may be coupled to the SoC(s) 1604 via a high-speed interconnect (e.g., NVIDIA's NVLINK). The GPU(s) 1620 may provide additional artificial intelligence functionality, such as by executing redundant and/or different neural networks, and may be used to train and/or update neural networks based on input (e.g., sensor data) from sensors of the vehicle 1600.

The vehicle 1600 may further include the network interface 1624 which may include one or more wireless antennas 1626 (e.g., one or more wireless antennas for different communication protocols, such as a cellular antenna, a Bluetooth antenna, etc.). The network interface 1624 may be used to enable wireless connectivity over the Internet with the cloud (e.g., with the server(s) 1678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1600 information about vehicles in proximity to the vehicle 1600 (e.g., vehicles in front of, on the side of, and/or behind the vehicle 1600). This functionality may be part of a cooperative adaptive cruise control functionality of the vehicle 1600.

The network interface 1624 may include a SoC that provides modulation and demodulation functionality and enables the controller(s) 1636 to communicate over wireless networks. The network interface 1624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1600 may further include data store(s) 1628 which may include off-chip (e.g., off the SoC(s) 1604) storage. The data store(s) 1628 may include one or more storage elements including RAM, SRAM, DRAM, VRAM, Flash, hard disks, and/or other components and/or devices that may store at least one bit of data.

The vehicle 1600 may further include GNSS sensor(s) 1658. The GNSS sensor(s) 1658 (e.g., GPS, assisted GPS sensors, differential GPS (DGPS) sensors, etc.), to assist in mapping, perception, occupancy grid generation, and/or path planning functions. Any number of GNSS sensor(s) 1658 may be used, including, for example and without limitation, a GPS using a USB connector with an Ethernet to Serial (RS-232) bridge.

The vehicle 1600 may further include RADAR sensor(s) 1660. The RADAR sensor(s) 1660 may be used by the vehicle 1600 for long-range vehicle detection, even in darkness and/or severe weather conditions. RADAR functional safety levels may be ASIL B. The RADAR sensor(s) 1660 may use the CAN and/or the bus 1602 (e.g., to transmit data generated by the RADAR sensor(s) 1660) for control and to access object tracking data, with access to Ethernet to access raw data in some examples. A wide variety of RADAR sensor types may be used. For example, and without limitation, the RADAR sensor(s) 1660 may be suitable for front, rear, and side RADAR use. In some example, Pulse Doppler RADAR sensor(s) are used.

The RADAR sensor(s) 1660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1600 surroundings at higher speeds with minimal interference from traffic in adjacent lanes. The other two antennae may expand the field of view, making it possible to quickly detect vehicles entering or leaving the vehicle's 1600 lane.

Mid-range RADAR systems may include, as an example, a range of up to 1660 m (front) or 80 m (rear), and a field of view of up to 42 degrees (front) or 1650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1600 may further include ultrasonic sensor(s) 1662. The ultrasonic sensor(s) 1662, which may be positioned at the front, back, and/or the sides of the vehicle 1600, may be used for park assist and/or to create and update an occupancy grid. A wide variety of ultrasonic sensor(s) 1662 may be used, and different ultrasonic sensor(s) 1662 may be used for different ranges of detection (e.g., 2.5 m, 4 m). The ultrasonic sensor(s) 1662 may operate at functional safety levels of ASIL B.

The vehicle 1600 may include LIDAR sensor(s) 1664. The LIDAR sensor(s) 1664 may be used for object and pedestrian detection, emergency braking, collision avoidance, and/or other functions. The LIDAR sensor(s) 1664 may be functional safety level ASIL B. In some examples, the vehicle 1600 may include multiple LIDAR sensors 1664 (e.g., two, four, six, etc.) that may use Ethernet (e.g., to provide data to a Gigabit Ethernet switch).

In some examples, the LIDAR sensor(s) 1664 may be capable of providing a list of objects and their distances for a 360-degree field of view. Commercially available LIDAR sensor(s) 1664 may have an advertised range of approximately 1600 m, with an accuracy of 2 cm-3 cm, and with support for a 1600 Mbps Ethernet connection, for example. In some examples, one or more non-protruding LIDAR sensors 1664 may be used. In such examples, the LIDAR sensor(s) 1664 may be implemented as a small device that may be embedded into the front, rear, sides, and/or corners of the vehicle 1600. The LIDAR sensor(s) 1664, in such examples, may provide up to a 120-degree horizontal and 35-degree vertical field-of-view, with a 200 m range even for low-reflectivity objects. Front-mounted LIDAR sensor(s) 1664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1664 may be less susceptible to motion blur, vibration, and/or shock.

The vehicle may further include IMU sensor(s) 1666. The IMU sensor(s) 1666 may be located at a center of the rear axle of the vehicle 1600, in some examples. The IMU sensor(s) 1666 may include, for example and without limitation, an accelerometer(s), a magnetometer(s), a gyroscope(s), a magnetic compass(es), and/or other sensor types. In some examples, such as in six-axis applications, the IMU sensor(s) 1666 may include accelerometers and gyroscopes, while in nine-axis applications, the IMU sensor(s) 1666 may include accelerometers, gyroscopes, and magnetometers.

In some embodiments, the IMU sensor(s) 1666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1666 may enable the vehicle 1600 to estimate heading without requiring input from a magnetic sensor by directly observing and correlating the changes in velocity from GPS to the IMU sensor(s) 1666. In some examples, the IMU sensor(s) 1666 and the GNSS sensor(s) 1658 may be combined in a single integrated unit.

The vehicle may include microphone(s) 1696 placed in and/or around the vehicle 1600. The microphone(s) 1696 may be used for emergency vehicle detection and identification, among other things.

The vehicle may further include any number of camera types, including stereo camera(s) 1668, wide-view camera(s) 1670, infrared camera(s) 1672, surround camera(s) 1674, long-range and/or mid-range camera(s) 1698, and/or other camera types. The cameras may be used to capture image data around an entire periphery of the vehicle 1600. The types of cameras used depends on the embodiments and requirements for the vehicle 1600, and any combination of camera types may be used to provide the necessary coverage around the vehicle 1600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 16A and FIG. 16B.

The vehicle 1600 may further include vibration sensor(s) 1642. The vibration sensor(s) 1642 may measure vibrations of components of the vehicle, such as the axle(s). For example, changes in vibrations may indicate a change in road surfaces. In another example, when two or more vibration sensors 1642 are used, the differences between the vibrations may be used to determine friction or slippage of the road surface (e.g., when the difference in vibration is between a power-driven axle and a freely rotating axle).

The vehicle 1600 may include an ADAS system 1638. The ADAS system 1638 may include a SoC, in some examples. The ADAS system 1638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1660, LIDAR sensor(s) 1664, and/or a camera(s). The ACC systems may include longitudinal ACC and/or lateral ACC. Longitudinal ACC monitors and controls the distance to the vehicle immediately ahead of the vehicle 1600 and automatically adjust the vehicle speed to maintain a safe distance from vehicles ahead. Lateral ACC performs distance keeping, and advises the vehicle 1600 to change lanes when necessary. Lateral ACC is related to other ADAS applications such as LCA and CWS.

CACC uses information from other vehicles that may be received via the network interface 1624 and/or the wireless antenna(s) 1626 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1600), while the I2V communication concept provides information about traffic further ahead. CACC systems may include either or both I2V and V2V information sources. Given the information of the vehicles ahead of the vehicle 1600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1600 if the vehicle 1600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1600 is backing up. Some RCTW systems include AEB to ensure that the vehicle brakes are applied to avoid a crash. RCTW systems may use one or more rear-facing RADAR sensor(s) 1660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1600, the vehicle 1600 itself must, in the case of conflicting results, decide whether to heed the result from a primary computer or a secondary computer (e.g., a first controller 1636 or a second controller 1636). For example, in some embodiments, the ADAS system 1638 may be a backup and/or secondary computer for providing perception information to a backup computer rationality module. The backup computer rationality monitor may run a redundant diverse software on hardware components to detect faults in perception and dynamic driving tasks. Outputs from the ADAS system 1638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1604.

In other examples, ADAS system 1638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1638 may be fed into the primary computer's perception block and/or the primary computer's dynamic driving task block. For example, if the ADAS system 1638 indicates a forward crash warning due to an object immediately ahead, the perception block may use this information when identifying objects. In other examples, the secondary computer may have its own neural network which is trained and thus reduces the risk of false positives, as described herein.

The vehicle 1600 may further include the infotainment SoC 1630 (e.g., an in-vehicle infotainment system (IVI)). Although illustrated and described as a SoC, the infotainment system may not be a SoC, and may include two or more discrete components. The infotainment SoC 1630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1600. For example, the infotainment SoC 1630 may radios, disk players, navigation systems, video players, USB and Bluetooth connectivity, carputers, in-car entertainment, Wi-Fi, steering wheel audio controls, hands free voice control, a heads-up display (HUD), an HMI display 1634, a telematics device, a control panel (e.g., for controlling and/or interacting with various components, features, and/or systems), and/or other components. The infotainment SoC 1630 may further be used to provide information (e.g., visual and/or audible) to a user(s) of the vehicle, such as information from the ADAS system 1638, autonomous driving information such as planned vehicle maneuvers, trajectories, surrounding environment information (e.g., intersection information, vehicle information, road information, etc.), and/or other information.

The infotainment SoC 1630 may include GPU functionality. The infotainment SoC 1630 may communicate over the bus 1602 (e.g., CAN bus, Ethernet, etc.) with other devices, systems, and/or components of the vehicle 1600. In some examples, the infotainment SoC 1630 may be coupled to a supervisory MCU such that the GPU of the infotainment system may perform some self-driving functions in the event that the primary controller(s) 1636 (e.g., the primary and/or backup computers of the vehicle 1600) fail. In such an example, the infotainment SoC 1630 may put the vehicle 1600 into a chauffeur to safe stop mode, as described herein.

The vehicle 1600 may further include an instrument cluster 1632 (e.g., a digital dash, an electronic instrument cluster, a digital instrument panel, etc.). The instrument cluster 1632 may include a controller and/or supercomputer (e.g., a discrete controller or supercomputer). The instrument cluster 1632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1630 and the instrument cluster 1632. In other words, the instrument cluster 1632 may be included as part of the infotainment SoC 1630, or vice versa.

FIG. 16D is a system diagram for communication between cloud-based server(s) and the example autonomous vehicle 1600 of FIG. 16A, in accordance with some embodiments of the present disclosure. The system 1676 may include server(s) 1678, network(s) 1690, and vehicles, including the vehicle 1600. The server(s) 1678 may include a plurality of GPUs 1684(A)-1684(H) (collectively referred to herein as GPUs 1684), PCIe switches 1682(A)-1682(H) (collectively referred to herein as PCIe switches 1682), and/or CPUs 1680(A)-1680(B) (collectively referred to herein as CPUs 1680). The GPUs 1684, the CPUs 1680, and the PCIe switches may be interconnected with high-speed interconnects such as, for example and without limitation, NVLink interfaces 1688 developed by NVIDIA and/or PCIe connections 1686. In some examples, the GPUs 1684 are connected via NVLink and/or NVSwitch SoC and the GPUs 1684 and the PCIe switches 1682 are connected via PCIe interconnects. Although eight GPUs 1684, two CPUs 1680, and two PCIe switches are illustrated, this is not intended to be limiting. Depending on the embodiment, each of the server(s) 1678 may include any number of GPUs 1684, CPUs 1680, and/or PCIe switches. For example, the server(s) 1678 may each include eight, sixteen, thirty-two, and/or more GPUs 1684.

The server(s) 1678 may receive, over the network(s) 1690 and from the vehicles, image data representative of images showing unexpected or changed road conditions, such as recently commenced road-work. The server(s) 1678 may transmit, over the network(s) 1690 and to the vehicles, neural networks 1692, updated neural networks 1692, and/or map information 1694, including information regarding traffic and road conditions. The updates to the map information 1694 may include updates for the HD map 1622, such as information regarding construction sites, potholes, detours, flooding, and/or other obstructions. In some examples, the neural networks 1692, the updated neural networks 1692, and/or the map information 1694 may have resulted from new training and/or experiences represented in data received from any number of vehicles in the environment, and/or based on training performed at a datacenter (e.g., using the server(s) 1678 and/or other servers).

The server(s) 1678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1690, and/or the machine learning models may be used by the server(s) 1678 to remotely monitor the vehicles.

In some examples, the server(s) 1678 may receive data from the vehicles and apply the data to up-to-date real-time neural networks for real-time intelligent inferencing. The server(s) 1678 may include deep-learning supercomputers and/or dedicated AI computers powered by GPU(s) 1684, such as a DGX and DGX Station machines developed by NVIDIA. However, in some examples, the server(s) 1678 may include deep learning infrastructure that use only CPU-powered datacenters.

The deep-learning infrastructure of the server(s) 1678 may be capable of fast, real-time inferencing, and may use that capability to evaluate and verify the health of the processors, software, and/or associated hardware in the vehicle 1600. For example, the deep-learning infrastructure may receive periodic updates from the vehicle 1600, such as a sequence of images and/or objects that the vehicle 1600 has located in that sequence of images (e.g., via computer vision and/or other machine learning object classification techniques). The deep-learning infrastructure may run its own neural network to identify the objects and compare them with the objects identified by the vehicle 1600 and, if the results do not match and the infrastructure concludes that the AI in the vehicle 1600 is malfunctioning, the server(s) 1678 may transmit a signal to the vehicle 1600 instructing a fail-safe computer of the vehicle 1600 to assume control, notify the passengers, and complete a safe parking maneuver.

For inferencing, the server(s) 1678 may include the GPU(s) 1684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 17 is a block diagram of an example computing device(s) 1700 suitable for use in implementing some embodiments of the present disclosure. Computing device 1700 may include an interconnect system 1702 that directly or indirectly couples the following devices: memory 1704, one or more central processing units (CPUs) 1706, one or more graphics processing units (GPUs) 1708, a communication interface 1710, input/output (I/O) ports 1712, input/output components 1714, a power supply 1716, one or more presentation components 1718 (e.g., display(s)), and one or more logic units 1720. In at least one embodiment, the computing device(s) 1700 may comprise one or more virtual machines (VMs), and/or any of the components thereof may comprise virtual components (e.g., virtual hardware components). For non-limiting examples, one or more of the GPUs 1708 may comprise one or more vGPUs, one or more of the CPUs 1706 may comprise one or more vCPUs, and/or one or more of the logic units 1720 may comprise one or more virtual logic units. As such, a computing device(s) 1700 may include discrete components (e.g., a full GPU dedicated to the computing device 1700), virtual components (e.g., a portion of a GPU dedicated to the computing device 1700), or a combination thereof.

Although the various blocks of FIG. 17 are shown as connected via the interconnect system 1702 with lines, this is not intended to be limiting and is for clarity only. For example, in some embodiments, a presentation component 1718, such as a display device, may be considered an I/O component 1714 (e.g., if the display is a touch screen). As another example, the CPUs 1706 and/or GPUs 1708 may include memory (e.g., the memory 1704 may be representative of a storage device in addition to the memory of the GPUs 1708, the CPUs 1706, and/or other components). In other words, the computing device of FIG. 17 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 17.

The interconnect system 1702 may represent one or more links or busses, such as an address bus, a data bus, a control bus, or a combination thereof. The interconnect system 1702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1706 may be directly connected to the memory 1704. Further, the CPU 1706 may be directly connected to the GPU 1708. Where there is direct, or point-to-point connection between components, the interconnect system 1702 may include a PCIe link to carry out the connection. In these examples, a PCI bus need not be included in the computing device 1700.

The memory 1704 may include any of a variety of computer-readable media. The computer-readable media may be any available media that may be accessed by the computing device 1700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1706 may be configured to execute at least some of the computer-readable instructions to control one or more components of the computing device 1700 to perform one or more of the methods and/or processes described herein. The CPU(s) 1706 may each include one or more cores (e.g., one, two, four, eight, twenty-eight, seventy-two, etc.) that are capable of handling a multitude of software threads simultaneously. The CPU(s) 1706 may include any type of processor, and may include different types of processors depending on the type of computing device 1700 implemented (e.g., processors with fewer cores for mobile devices and processors with more cores for servers). For example, depending on the type of computing device 1700, the processor may be an Advanced RISC Machines (ARM) processor implemented using Reduced Instruction Set Computing (RISC) or an x86 processor implemented using Complex Instruction Set Computing (CISC). The computing device 1700 may include one or more CPUs 1706 in addition to one or more microprocessors or supplementary co-processors, such as math co-processors.

In addition to or alternatively from the CPU(s) 1706, the GPU(s) 1708 may be configured to execute at least some of the computer-readable instructions to control one or more components of the computing device 1700 to perform one or more of the methods and/or processes described herein. One or more of the GPU(s) 1708 may be an integrated GPU (e.g., with one or more of the CPU(s) 1706 and/or one or more of the GPU(s) 1708 may be a discrete GPU. In embodiments, one or more of the GPU(s) 1708 may be a coprocessor of one or more of the CPU(s) 1706. The GPU(s) 1708 may be used by the computing device 1700 to render graphics (e.g., 3D graphics) or perform general purpose computations. For example, the GPU(s) 1708 may be used for General-Purpose computing on GPUs (GPGPU). The GPU(s) 1708 may include hundreds or thousands of cores that are capable of handling hundreds or thousands of software threads simultaneously. The GPU(s) 1708 may generate pixel data for output images in response to rendering commands (e.g., rendering commands from the CPU(s) 1706 received via a host interface). The GPU(s) 1708 may include graphics memory, such as display memory, for storing pixel data or any other suitable data, such as GPGPU data. The display memory may be included as part of the memory 1704. The GPU(s) 1708 may include two or more GPUs operating in parallel (e.g., via a link). The link may directly connect the GPUs (e.g., using NVLINK) or may connect the GPUs through a switch (e.g., using NVSwitch). When combined together, each GPU 1708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1706 and/or the GPU(s) 1708, the logic unit(s) 1720 may be configured to execute at least some of the computer-readable instructions to control one or more components of the computing device 1700 to perform one or more of the methods and/or processes described herein. In embodiments, the CPU(s) 1706, the GPU(s) 1708, and/or the logic unit(s) 1720 may discretely or jointly perform any combination of the methods, processes and/or portions thereof. One or more of the logic units 1720 may be part of and/or integrated in one or more of the CPU(s) 1706 and/or the GPU(s) 1708 and/or one or more of the logic units 1720 may be discrete components or otherwise external to the CPU(s) 1706 and/or the GPU(s) 1708. In embodiments, one or more of the logic units 1720 may be a coprocessor of one or more of the CPU(s) 1706 and/or one or more of the GPU(s) 1708.

Examples of the logic unit(s) 1720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1710 may include one or more receivers, transmitters, and/or transceivers that enable the computing device 1700 to communicate with other computing devices via an electronic communication network, included wired and/or wireless communications. The communication interface 1710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1720 and/or communication interface 1710 may include one or more data processing units (DPUs) to transmit data received over a network and/or through interconnect system 1702 directly to (e.g., a memory of) one or more GPU(s) 1708.

The I/O ports 1712 may enable the computing device 1700 to be logically coupled to other devices including the I/O components 1714, the presentation component(s) 1718, and/or other components, some of which may be built in to (e.g., integrated in) the computing device 1700. Illustrative I/O components 1714 include a microphone, mouse, keyboard, joystick, game pad, game controller, satellite dish, scanner, printer, wireless device, etc. The I/O components 1714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1700. The computing device 1700 may be include depth cameras, such as stereoscopic camera systems, infrared camera systems, RGB camera systems, touchscreen technology, and combinations of these, for gesture detection and recognition. Additionally, the computing device 1700 may include accelerometers or gyroscopes (e.g., as part of an inertia measurement unit (IMU)) that enable detection of motion. In some examples, the output of the accelerometers or gyroscopes may be used by the computing device 1700 to render immersive augmented reality or virtual reality.

The power supply 1716 may include a hard-wired power supply, a battery power supply, or a combination thereof. The power supply 1716 may provide power to the computing device 1700 to enable the components of the computing device 1700 to operate.

The presentation component(s) 1718 may include a display (e.g., a monitor, a touch screen, a television screen, a heads-up-display (HUD), other display types, or a combination thereof), speakers, and/or other presentation components. The presentation component(s) 1718 may receive data from other components (e.g., the GPU(s) 1708, the CPU(s) 1706, DPUs, etc.), and output the data (e.g., as an image, video, sound, etc.).

### Example Data Center

FIG. 18 illustrates an example data center 1800 that may be used in at least one embodiments of the present disclosure. The data center 1800 may include a data center infrastructure layer 1810, a framework layer 1820, a software layer 1830, and/or an application layer 1840.

As shown in FIG. 18, the data center infrastructure layer 1810 may include a resource orchestrator 1812, grouped computing resources 1814, and node computing resources (“node C.R.s”) 1816(1)-1816(N), where “N” represents any whole, positive integer. In at least one embodiment, node C.R.s 1816(1)-1816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1816(1)-1816(N) may correspond to a server having one or more of the above-mentioned computing resources. In addition, in some embodiments, the node C.R.s 1816(1)-18161(N) may include one or more virtual components, such as vGPUs, vCPUs, and/or the like, and/or one or more of the node C.R.s 1816(1)-1816(N) may correspond to a virtual machine (VM).

In at least one embodiment, grouped computing resources 1814 may include separate groupings of node C.R.s 1816 housed within one or more racks (not shown), or many racks housed in data centers at various geographical locations (also not shown). Separate groupings of node C.R.s 1816 within grouped computing resources 1814 may include grouped compute, network, memory or storage resources that may be configured or allocated to support one or more workloads. In at least one embodiment, several node C.R.s 1816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1812 may configure or otherwise control one or more node C.R.s 1816(1)-1816(N) and/or grouped computing resources 1814. In at least one embodiment, resource orchestrator 1812 may include a software design infrastructure (SDI) management entity for the data center 1800. The resource orchestrator 1812 may include hardware, software, or some combination thereof.

In at least one embodiment, as shown in FIG. 18, framework layer 1820 may include a job scheduler 1833, a configuration manager 1834, a resource manager 1836, and/or a distributed file system 1838. The framework layer 1820 may include a framework to support software 1832 of software layer 1830 and/or one or more application(s) 1842 of application layer 1840. The software 1832 or application(s) 1842 may respectively include web-based service software or applications, such as those provided by Amazon Web Services, Google Cloud and Microsoft Azure. The framework layer 1820 may be, but is not limited to, a type of free and open-source software web application framework such as Apache Spark™ (hereinafter “Spark”) that may utilize distributed file system 1838 for large-scale data processing (e.g., “big data”). In at least one embodiment, job scheduler 1833 may include a Spark driver to facilitate scheduling of workloads supported by various layers of data center 1800. The configuration manager 1834 may be capable of configuring different layers such as software layer 1830 and framework layer 1820 including Spark and distributed file system 1838 for supporting large-scale data processing. The resource manager 1836 may be capable of managing clustered or grouped computing resources mapped to or allocated for support of distributed file system 1838 and job scheduler 1833. In at least one embodiment, clustered or grouped computing resources may include grouped computing resource 1814 at data center infrastructure layer 1810. The resource manager 1836 may coordinate with resource orchestrator 1812 to manage these mapped or allocated computing resources.

In at least one embodiment, software 1832 included in software layer 1830 may include software used by at least portions of node C.R.s 1816(1)-1816(N), grouped computing resources 1814, and/or distributed file system 1838 of framework layer 1820. One or more types of software may include, but are not limited to, Internet web page search software, e-mail virus scan software, database software, and streaming video content software.

In at least one embodiment, application(s) 1842 included in application layer 1840 may include one or more types of applications used by at least portions of node C.R.s 1816(1)-1816(N), grouped computing resources 1814, and/or distributed file system 1838 of framework layer 1820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1834, resource manager 1836, and resource orchestrator 1812 may implement any number and type of self-modifying actions based on any amount and type of data acquired in any technically feasible fashion. Self-modifying actions may relieve a data center operator of data center 1800 from making possibly bad configuration decisions and possibly avoiding underutilized and/or poor performing portions of a data center.

The data center 1800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1800. In at least one embodiment, trained or deployed machine learning models corresponding to one or more neural networks may be used to infer or predict information using resources described above with respect to the data center 1800 by using weight parameters calculated through one or more training techniques, such as but not limited to those described herein.

In at least one embodiment, the data center 1800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1700 of FIG. 17—e.g., each device may include similar components, features, and/or functionality of the computing device(s) 1700. In addition, where backend devices (e.g., servers, NAS, etc.) are implemented, the backend devices may be included as part of a data center 1800, an example of which is described in more detail herein with respect to FIG. 18.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1700 described herein with respect to FIG. 17. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: determining a set of spheres associated with a surface mesh that represents an object; determining a set of points located on the surface mesh; determining, based at least on the set of points, an updated set of spheres associated with the surface mesh by removing one or more spheres from the set of spheres; and performing one or more operations using at least the updated set of spheres.

B: The method of paragraph A, further comprising: determining that a point of the set of points is enclosed by a single sphere of the set of spheres, wherein the determining the updated set of spheres further includes adding the single sphere to the updated set of spheres based at least on the point being enclosed by the single sphere.

C: The method of paragraph B, further comprising: determining an updated set of points by removing at least one of the point or one or more additional points enclosed by the single sphere from the set of points, wherein the determining the updated set of spheres associated with the surface mesh is based at least on the updated set of points.

D: The method of any one of paragraphs A-C, wherein the determining the updated set of spheres associated with the surface mesh comprises: determining that one or more points from the set of points that are enclosed by a first sphere from the one or more spheres are also enclosed by one or more second spheres from the set of spheres; and removing, based at least on the one or more points being enclosed by the one or more second spheres, the first sphere from the set of spheres.

E: The method of any one of paragraphs A-D, further comprising: generating a map that indicates at least a point from the set of points is enclosed by the one or more spheres from the set of spheres, wherein the determining the updated set of spheres associated with the surface mesh is based at least on the map.

F: The method of any one of paragraphs A-E, further comprising: determining a bounding shape that at least partially encloses the surface mesh; and determining, based at least on performing random sampling, a second set of points that are enclosed within the bounding shape, wherein the determining the set of spheres associated with the surface mesh is based at least on the second set points.

G: The method of paragraph F, further comprising: determining that at least one or more first points of the second set of points is located inside the surface mesh and one or more second points of the second set of points is located outside of the surface mesh, wherein the determining the set of spheres associated with the surface mesh is further based at least on the one or more first points being located inside the surface mesh and the one or more second points being located outside of the surface mesh.

H: The method of paragraph F, further comprising: determining one or more distances between the second set of points and one or more closest points located on the surface mesh; and determining an updated second set of points by removing at least one or more points of the second set of points is based at least on the one or more distances, wherein the determining the set of spheres associated with the surface mesh is based at least on the updated second set points.

I: The method of paragraph F, further comprising: determining one or more first distances between the second set of points and one or more closest points located on the surface mesh; determining a second distance associated with the set of spheres overlapping the surface mesh; and determining one or more third distances based at least on the one or more first distances and the second distance, wherein the determining the set of spheres associated with the surface mesh comprises at least generating the set of spheres to include one or more centers at the second set of points and radiuses that include the one or more third distances.

J: The method of any one of paragraphs A-I, wherein the performing the one or more operations using the updated set of spheres comprises one or more of: determining whether the object is in contact with another object is based at least on the updated set of spheres; or storing data that associates the updated set of spheres with the object.

K: A system comprising: one or more processors to: receive one or more inputs indicating a number of points associated with a surface mesh that represents an object; determine, based at least on the number of points, a set of points associated with the surface mesh; determine, based at least on the set of points, a set of spheres associated with the surface mesh; and perform one or more operations using at least the set of spheres.

L: The system of paragraph K, wherein the one or more processors are further to: determine a bounding shape that encloses at least a portion of the surface mesh, wherein the determination of the set of points associated with the surface mesh is further based at least on performing random sampling within the bounding shape.

M: The system of either paragraph K or paragraph L, wherein the one or more processors are further to: determine that at least one or more first points of the set of points is located inside the surface mesh and one or more second points of the set of points is located outside of the surface mesh, wherein the determination of the set of spheres associated with the surface mesh is further based at least on the one or more first points being located inside the surface mesh and the one or more second points being located outside of the surface mesh.

N: The system of any one of paragraphs K-M, wherein the one or more processors are further to: determine one or more distances between the set of points and one or more closest points located on the surface mesh; and determine an updated set of points by removing at least one or more points from the set of points based at least on the one or more distances, wherein the determination of the set of spheres associated with the surface mesh is based at least on the updated set of points.

O: The system of any one of paragraphs K-N, wherein the one or more processors are further to: determine one or more first distances between the set of points and one or more closest points located on the surface mesh; determine a second distance associated with the set of spheres overlapping the surface mesh; and determine one or more third distances based at least on the one or more first distances and the second distance, wherein the determination of the set of spheres associated with the surface mesh is further based at least on the one or more third distances.

P: The system of any one of paragraphs K-O, wherein the determination of the set of spheres associated with the surface mesh comprises: determining a second set of spheres associated with the surface mesh based at least on the set of points; determining a second set of points located on the surface mesh; and determining, based at least on the second set of points, the set of spheres associated with the surface mesh by removing one or more spheres from the second set of spheres.

Q: The system of paragraph P, wherein the determination of the set of spheres associated with the surface mesh further comprises: determining that a point of the second set of points is enclosed by a single sphere of the second set of spheres; and adding the single sphere to the set of spheres based at least on the point being enclosed by the single sphere.

R: The system of any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to determine a first set of spheres associated with a surface mesh that represents an object, wherein the determination of the first set of spheres is based at least on adding a first sphere from a second set of spheres to the first set of spheres based at least on the first sphere enclosing a first point located on the surface mesh or removing at least a second sphere from the second set of spheres based at least on multiple spheres from the second set of spheres enclosing a second point located on the surface mesh.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining a set of spheres associated with a surface mesh that represents an object;
determining a set of points located on the surface mesh;
determining, based at least on the set of points, an updated set of spheres associated with the surface mesh by removing one or more spheres from the set of spheres; and
performing one or more operations using at least the updated set of spheres.

2. The method of claim 1, further comprising:
determining that a point of the set of points is enclosed by a single sphere of the set of spheres,
wherein the determining the updated set of spheres further includes adding the single sphere to the updated set of spheres based at least on the point being enclosed by the single sphere.

3. The method of claim 2, further comprising:
determining an updated set of points by removing at least one of the point or one or more additional points enclosed by the single sphere from the set of points,
wherein the determining the updated set of spheres associated with the surface mesh is based at least on the updated set of points.

4. The method of claim 1, wherein the determining the updated set of spheres associated with the surface mesh comprises:
determining that one or more points from the set of points that are enclosed by a first sphere from the one or more spheres are also enclosed by one or more second spheres from the set of spheres; and
removing, based at least on the one or more points being enclosed by the one or more second spheres, the first sphere from the set of spheres.

5. The method of claim 1, further comprising:
generating a map that indicates at least a point from the set of points is enclosed by the one or more spheres from the set of spheres,
wherein the determining the updated set of spheres associated with the surface mesh is based at least on the map.

6. The method of claim 1, further comprising:
determining a bounding shape that at least partially encloses the surface mesh; and
determining, based at least on performing random sampling, a second set of points that are enclosed within the bounding shape,
wherein the determining the set of spheres associated with the surface mesh is based at least on the second set points.

7. The method of claim 6, further comprising:
determining that at least one or more first points of the second set of points is located inside the surface mesh and one or more second points of the second set of points is located outside of the surface mesh,
wherein the determining the set of spheres associated with the surface mesh is further based at least on the one or more first points being located inside the surface mesh and the one or more second points being located outside of the surface mesh.

8. The method of claim 6, further comprising:
determining one or more distances between the second set of points and one or more closest points located on the surface mesh; and
determining an updated second set of points by removing at least one or more points of the second set of points is based at least on the one or more distances,
wherein the determining the set of spheres associated with the surface mesh is based at least on the updated second set points.

9. The method of claim 6, further comprising:
determining one or more first distances between the second set of points and one or more closest points located on the surface mesh;
determining a second distance associated with the set of spheres overlapping the surface mesh; and
determining one or more third distances based at least on the one or more first distances and the second distance,
wherein the determining the set of spheres associated with the surface mesh comprises at least generating the set of spheres to include one or more centers at the second set of points and radiuses that include the one or more third distances.

10. The method of claim 1, wherein the performing the one or more operations using the updated set of spheres comprises one or more of:
determining whether the object is in contact with another object is based at least on the updated set of spheres; or
storing data that associates the updated set of spheres with the object.

11. A system comprising:
one or more processors to:
receive one or more inputs indicating a number of points associated with a surface mesh that represents an object;
determine, based at least on the number of points, a set of points associated with the surface mesh;
determine, based at least on the set of points, a set of spheres associated with the surface mesh; and
perform one or more operations using at least the set of spheres.

12. The system of claim 11, wherein the one or more processors are further to:
determine a bounding shape that encloses at least a portion of the surface mesh,
wherein the determination of the set of points associated with the surface mesh is further based at least on performing random sampling within the bounding shape.

13. The system of claim 11, wherein the one or more processors are further to:
determine that at least one or more first points of the set of points is located inside the surface mesh and one or more second points of the set of points is located outside of the surface mesh,
wherein the determination of the set of spheres associated with the surface mesh is further based at least on the one or more first points being located inside the surface mesh and the one or more second points being located outside of the surface mesh.

14. The system of claim 11, wherein the one or more processors are further to:
determine one or more distances between the set of points and one or more closest points located on the surface mesh; and
determine an updated set of points by removing at least one or more points from the set of points based at least on the one or more distances,
wherein the determination of the set of spheres associated with the surface mesh is based at least on the updated set of points.

15. The system of claim 11, wherein the one or more processors are further to:
determine one or more first distances between the set of points and one or more closest points located on the surface mesh;
determine a second distance associated with the set of spheres overlapping the surface mesh; and
determine one or more third distances based at least on the one or more first distances and the second distance,
wherein the determination of the set of spheres associated with the surface mesh is further based at least on the one or more third distances.

16. The system of claim 11, wherein the determination of the set of spheres associated with the surface mesh comprises:
determining a second set of spheres associated with the surface mesh based at least on the set of points;
determining a second set of points located on the surface mesh; and
determining, based at least on the second set of points, the set of spheres associated with the surface mesh by removing one or more spheres from the second set of spheres.

17. The system of claim 16, wherein the determination of the set of spheres associated with the surface mesh further comprises:
determining that a point of the second set of points is enclosed by a single sphere of the second set of spheres; and
adding the single sphere to the set of spheres based at least on the point being enclosed by the single sphere.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to determine a first set of spheres associated with a surface mesh that represents an object, wherein the determination of the first set of spheres is based at least on adding a first sphere from a second set of spheres to the first set of spheres based at least on the first sphere enclosing a first point located on the surface mesh or removing at least a second sphere from the second set of spheres based at least on multiple spheres from the second set of spheres enclosing a second point located on the surface mesh.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
